(19) United States
(12) Patent Application Publication
(10) Pub. No.: US 2005/0271421 A1
(43) Pub. Date: Dec. 8, 2005

(54) Calibration method for exposure device, exposure method and exposure device

(75) Inventors: Hiroshi Uemura, Kanagawa (JP); Takeshi Fukuda, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/094,504

(22) Filed: Mar. 31, 2005

(30) Foreign Application Priority Data
Mar. 31, 2004 (JP) 2004-107120

(51) Int. Cl. G03G 15/04

(52) U.S. Cl. 399/191

(57) ABSTRACT

In this exposure system, alignment marks on a photosensitive material are photographed with a reading unit. Prior to this photographing, a standard board, having detection marks at positions readable to the reading unit at preset intervals along the movement direction of the reading unit, is provided. At least one of the detection marks is photographed with the reading unit, which is arranged in a position to photograph the alignment marks provided on the photosensitive material. Calibration data is calculated based on data on the camera optical axis deviation obtained by this photographing. Standard position data reflects the calibration data, whereby calibration of the exposure position adjustment function of the exposure device is performed.

### CROSS-REFERENCE TO RELATED APPLICATION

This application claims priority under 35 U.S.C. 119 from Japanese Patent Application No. 2004-107120, the disclosure of which is incorporated by reference herein.

### BACKGROUND OF THE INVENTION

1. Field of the Invention

The present invention relates to an exposure device and a calibration method for an exposure device. Specifically, the present invention relates to an exposure device and a calibration method in which an exposure device exposes a photosensitive material with light beams modulated with a spatial modulation element or the like in accordance with image data, and performs calibration with an exposure position adjustment function.

2. Description of the Related Art

Conventionally, there have been various proposals for exposure devices, such as those that use the spatial light modulation elements (SLM) of devices such as digital micro-mirror devices (DMD). In these devices, image exposure is performed using beams of light that have been modulated in accordance with image data.

A DMD, for example, is a mirror device having many micro-mirrors disposed two-dimensionally on a semiconductor substrate made of silicon or the like, and the angles of the reflective surfaces of the micro-mirrors change in response to control signals. Exposure devices with conventional digital scan-exposure methods (e.g., maskless exposure) utilizing such a DMD has an exposure head or scanner. This scanner is equipped with a light source that radiates laser beams, a lens system that collimates the lasers radiated from the light source, DMD arranged substantially at the focal point of the lens system, and a lens system for imaging the lasers reflected by the DMD onto a scanning surface. The on/off functions of each DMD micro-mirror are controlled to modulate the lasers with control signals generated in response to data such as image data. The modulated lasers are then used to scan-expose an image or pattern on a photosensitive material set on a stage and moved along a scanning direction (Y-direction).

Further, in order to accurately adjust the photosensitive material to the X-Y exposure position, prior to exposure the exposure device uses an alignment camera such as a CCD camera to photograph an alignment mark, which is provided on the photosensitive material and serves as the exposure position standard. Alignment is performed by adjusting the exposure position to the correct position based on the mark measurement position (standard position data) obtained via this photographing. Since the exposure device is used to expose various types of photosensitive materials, all with different sizes and alignment mark positions, the alignment camera must be able to photograph even when the position of the alignment mark in the scanning direction and the direction intersecting therewith changes. For example, the alignment camera, which is driven by a drive mechanism such as a ball screw, is guided by a device such as a guide rail extending along the scanning direction and the direction perpendicular thereto (X-direction). In this manner, the alignment camera can be optionally moved and arranged to any position within the region of the X-direction dimension of the object to be exposed. Subsequently, the position of the alignment camera is detected and measured by a position detection unit such as a near-scale unit, and this position is used as the standard in conducting the above-described alignment. An example of a publication describing such a device is Japanese Patent Application Laid-Open (JP-A) No. 8-222511.

In order to ensure the accuracy of this type of alignment function (exposure position adjustment function) calibration or correcting of each portion involved in alignment measurement is performed when the device is manufactured or maintenance is being performed thereon.

Various conventional technologies that relate to the calibration of alignment functions have been proposed. Exposure devices using methods where an image is scan-exposed by irradiating a photosensitive material with a laser have been proposed. The laser is irradiated while main-scanning the photosensitive material, which is moved in a sub-scanning direction.

An example of such a technique is described in JP-A No. 2000-329523. Predetermined processing in a processing unit is performed on a print circuit board mounted on a mounting table. Prior to this processing, however, the mounting table is provided with a standard mask formed from a standard pattern in a device that adjusts the position of the alignment scope, which measures the print circuit board. After the alignment scope is moved to a preset position of the standard pattern, calibration or correcting of the alignment scope position is performed based on the amount of position shift between the vertex of the standard pattern and the center of the alignment scope's field of vision. With this technique, position calibration of the alignment scope can be performed both easily and with high accuracy using a device having a simple configuration.

In the above-described digital scanning exposure method and the conventional devices using scanning methods involving main-scanning a laser, the alignment camera is moved to a position for photographing the alignment mark prior to exposure. When the alignment camera is moved, problems such as errors in the precision of the assembly and in each unit comprising the camera drive mechanism occur. The position of the alignment camera thus changes due to rolling, pitching and yawing, whereby the optical axis center of the photographing lens, set in the photographing position, shifts from its ordinary position. This type of position shift directly causes errors in alignment mark measurement. Accordingly, even if image exposure is performed after correcting the exposure position using the above-described alignment function, the alignment precision is affected by (and deteriorates due to) the position change that accompanies movement of the alignment camera. This is problematic in that the exposure position shifts from the correct position.

The techniques described in the above patent documents similarly do not consider the effects of this alignment camera position change factor. Accordingly, even if alignment adjustment or alignment function calibration are performed using these techniques, it is not possible to correct the shift in exposure position with good accuracy.

In the technique described in JP-A No. 2000-329523, multiple alignment scopes (four scopes) are set two-dimensionally. A large-scale standard mask formed from a two-dimensional latticed standard pattern is used to correct all four alignment scopes at once. In order to fit the standard mask to a drawing stage, the standard mask is set between the base of the drawing stage and the sucking or holding table, which is formed of transparent glass. By preparing the large-scale standard mask in this manner, the drawing stage is enlarged and weighted in the thickness direction, and furthermore, the sucking table is problematic in that it is made of glass, thus lowering its damage-resistance and durability against impact.

In conventional techniques, alignment scope position calibration is performed based on the amount of position shift between the standard pattern formed from the standard mask and the alignment scope. Nonetheless, in order to achieve a higher degree of precision in correcting the exposure position, it is preferable for position calibration of the alignment scope to be performed in another manner. For example, it is preferable to consider the connection with the position in light exposure and make the exposure position the standard.

### SUMMARY OF THE INVENTION

In light of the above facts, there is a need for an exposure device and calibration method for an exposure device in which it is possible to calibrate an exposure position adjustment function whose accuracy is adversely affected by positioning change of an alignment camera when the alignment camera moves to photograph alignment marks on a photosensitive material; and to improve the correction accuracy of exposure position deviation relative to the photosensitive material.

The present invention provides an exposure device and exposure method that can expose a desired image on a photosensitive material with high position accuracy based on the photographing of an alignment mark and the detection of an exposure beam position on an exposure surface.

The first embodiment of the present invention is the following exposure device. This exposure device has: a moving unit, on which a photosensitive material provided with a standard mark that is the standard of an exposure position is mounted, and which moves the photosensitive material in a direction along a scanning direction; a reading unit that reads the standard mark of the photosensitive material mounted on the moving unit; an exposure unit that exposes the photosensitive material moved by the moving unit with light beams modulated in accordance with image data; and a control unit that performs exposure position adjustment with the light beams based on the standard position data obtained by the reading of the standard mark by the reading unit with the exposure of the exposure unit. The control unit controls the exposure unit, and makes the exposure unit operate exposure. The exposure device further comprises a reading unit position scale, which is provided with multiple reading unit standard marks arranged along the moving direction of the reading unit and which is arranged in a position where it is possible for the multiple reading unit standard marks to be read by the reading unit; a read position data storing unit that, when the standard marks are read by the reading unit, which is arranged in a position for reading at least one standard mark from multiple reading unit standard marks, stores the position data of the reading unit obtained by the reading; a beam position detection unit provided with a detection unit that detects an exposure position with light beams; and an exposure point position information storage unit that stores exposure point position data obtained by detecting the exposure point position of a predetermined light beam outputted from the exposure unit with the beam position detection unit. With the exposure of the photosensitive material, the control unit reads out the standard position data read out from the data storage unit and the exposure point position data from the exposure point position information storage unit. Then the image data is exposed from the relative position relation of the reading unit standard mark of the beam position detection unit based on the standard position data and the exposure point position data.

With the present invention, an alignment mark is photographed and beam position of an exposure beam on the exposure surface is detected. Since exposure of the desired image on a photosensitive material is based on these, it is possible to expose an exposure image on a substrate with high position accuracy.

A second embodiment of the present invention is the following exposure device. This exposure device has a moving unit, on which a photosensitive material provided with a standard mark that is the standard of an exposure position is mounted, and which moves the photosensitive material in a direction along a scanning direction; a reading unit that reads the standard mark of the photosensitive material mounted on the moving unit; an exposure unit that exposes the photosensitive material moved by the moving unit with light beams modulated in accordance with image data; and a control unit that performs exposure position adjustment with the light beams based on the standard position data obtained by the reading of the standard mark by the reading unit with the exposure of the exposure unit. The control unit controls the exposure unit and makes the exposure unit operate exposure. The exposure device further comprises a reading position calibration component that is provided with multiple calibration standard marks arranged along the moving direction of the reading unit and is set in a position where the multiple calibration standard marks can be read by the reading unit; a calibration data storage unit, where at least one of multiple calibration standard marks is read with the reading unit arranged in a position to read the standard mark, and the calibration data storage unit stores calibration data calculated based on position data of the reading unit obtained by the reading; a beam position detection unit provided with a detection unit that detects an exposure position with light beams; an exposure point position information storage unit that stores exposure point position data obtained by detecting the exposure point position of a predetermined light beam outputted from the exposure unit with the beam position detection unit. With the exposure of the photosensitive material, the control unit reads out the calibration data from the calibration data storage unit and the standard position correcting data in which the calibration data is reflected in the standard position data, and the exposure point position data from the exposure point position information storage unit. It exposes the image data from the relative position relation of the reading unit standard mark of the beam position detection unit based on the standard position correcting data and the exposure point position data.

In the second embodiment of the present invention, an alignment mark formed on a substrate is photographed and the beam position of an exposure beam on the exposure surface is detected. Since exposure of the desired image on a photosensitive material is based on these, it is possible to expose an exposure image on a substrate with high position accuracy.

A third embodiment of the present invention is the following exposure device. This exposure device has a moving unit, on which a photosensitive material provided with a standard mark that is the standard of an exposure position is mounted, and which moves the photosensitive material in a direction along a scanning direction; a reading unit that is movable in a direction that intersects the scanning direction and which reads the standard mark of the photosensitive material mounted on the moving unit; an exposure unit that exposes the photosensitive material, moved by the moving unit, with light beams modulated in accordance with image data after reading by the reading unit; a control unit that performs exposure position adjustment with the light beams based on the standard position data obtained with the reading by the reading unit, with the exposure by the exposure unit; and that controls the exposure unit, and makes the exposure unit operate exposure. The exposure device further comprises a calibration component provided on the moving unit and provided with multiple calibration standard marks arranged at preset intervals along the moving direction of the reading unit and set in a position where the multiple calibration standard marks are readable by the reading unit; and a data storage unit that stores calibration data calculated based on position data of the reading unit obtained by reading of the reading unit, which is set in a position to read at least one standard mark from the multiple standard marks. With the exposure of the photosensitive material, the control unit reads out the calibration data from the data storage unit and makes the standard position data reflect the calibration data and performs exposure position adjustment, and controls the exposure unit to perform an exposure operation.

In the third embodiment of the present invention, calibration of the exposure position adjustment function, whose accuracy is adversely affected by position changes accompanying movement of the reading unit, is possible. The accuracy of corrections of deviation in exposure position relative to the photosensitive material can be improved.

The fourth embodiment of the present invention is the following exposure method. This exposure method utilizes a moving unit, on which a photosensitive material provided with a standard mark that is the standard of an exposure position is mounted, and which moves the photosensitive material in a direction along a scanning direction; a reading unit that reads the standard mark of the photosensitive material mounted on the moving unit; an exposure unit that exposes the photosensitive material, moved by the moving unit, with light beams modulated in accordance with image data; and a control unit that performs exposure position adjustment with the light beams based on the standard position data obtained by the reading of the standard mark by the reading unit with the exposure of the exposure unit. The control unit controls the exposure unit, and makes the exposure unit operate exposure. The exposure method further comprises the use of a reading unit position scale, which is provided with multiple reading unit standard marks arranged along the moving direction of the reading unit and which is arranged in a position where it is possible for the multiple reading unit standard marks to be read by the reading unit; a read position data storing unit that, when the standard marks are read by the reading unit arranged in a position for reading at least one standard mark from among the multiple reading unit standard marks, stores the position data of the reading unit obtained by the reading; a beam position detection unit provided with a detection unit that detects an exposure position with light beams; and an exposure point position information storage unit that stores exposure point position data obtained by detecting the exposure point position of a predetermined light beam outputted from the exposure unit with the beam position detection unit. With the exposure of the photosensitive material, the control unit reads out the standard position data read out from the data storage unit and the exposure point position data from the exposure point position information storage unit, and exposes the image data from the relative position relation of the reading unit standard mark of the beam position detection unit based on the standard position data and the exposure point position data.

With the fourth embodiment of the present invention, calibration of the exposure position adjustment function, whose accuracy is adversely affected by position changes accompanying movement of the reading unit, is possible. The accuracy of corrections of deviation in exposure position relative to the photosensitive material can be improved.

The fifth embodiment of the present invention is the following exposure method. This exposure method uses a moving unit, on which a photosensitive material provided with a standard mark that is the standard of an exposure position is mounted, and which moves the photosensitive material in a direction along a scanning direction; a reading unit that reads the standard mark of the photosensitive material mounted on the moving unit; an exposure unit that exposes the photosensitive material moved by the moving unit with light beams modulated in accordance with image data; and a control unit that performs exposure position adjustment with the light beams based on the standard position data obtained by the reading of the standard mark by the reading unit with the exposure of the exposure unit. The control unit controls the exposure unit and makes the exposure unit operate exposure. The exposure method further comprises the use of a reading position calibration component, which is provided with multiple calibration standard marks arranged along the moving direction of the reading unit and which is arranged in a position where it is possible for the multiple standard marks to be read by the reading unit; a calibration data storage unit, where at least one of the multiple calibration standard marks is read with the reading unit arranged in a position to read the standard mark, and the calibration data storage unit stores calibration data calculated based on position data of the reading unit obtained by the reading; a beam position detection unit provided with a detection unit that detects an exposure position with light beams; and an exposure point position information storage unit that stores exposure point position data obtained by detecting the exposure point position of a predetermined light beam outputted from the exposure unit with the beam position detection unit. With the exposure of the photosensitive material, the control unit reads out the calibration data from the calibration data storage unit, the standard position correcting data made to reflect the calibration data in the standard position data, and the exposure point position data from the exposure point position information storage unit. The control unit exposes the image data from the relative position relation of the reading unit standard mark of the beam position detection unit based on the standard position correcting data and the exposure point position data.

In the fifth embodiment of the present invention, alignment marks formed on a substrate are photographed and the beam position of an exposure beam is detected on the exposure surface. Since exposure of the desired image is performed on the photosensitive material based on these, the exposure image can be exposed on the exposure surface with a high degree of position accuracy.

The sixth embodiment of the present invention is an exposure method. This exposure method uses a moving unit, on which a photosensitive material provided with a standard mark that is the standard of an exposure position is mounted, and which moves the photosensitive material in a direction along a scanning direction; a reading unit that is movable in a direction that intersects the scanning direction and which reads the standard mark of the photosensitive material mounted on the moving unit; an exposure unit that exposes the photosensitive material, moved by the moving unit, with light beams modulated in accordance with image data after reading by the reading unit; and a control unit that performs exposure position adjustment, with the light beams based on the standard position data obtained with the reading by the reading unit, with the exposure by the exposure unit. The control unit controls the exposure unit, and makes the exposure unit operate exposure. The exposure method further comprises use of a calibration component provided on the moving unit and provided with multiple calibration standard marks arranged at preset intervals along the moving direction of the reading unit and set in a position where the multiple calibration standard marks are readable by the reading unit; a data storage unit that stores calibration data calculated based on position data of the reading unit obtained by reading of the reading unit, which is set in a position to read at least one standard mark from among the multiple calibration standard marks. With the exposure of the photosensitive material, the control unit reads out the calibration data from the data storage unit and makes the standard position data reflect the calibration data. The control unit performs exposure position adjustment, and controls the exposure unit to perform exposure operation.

With the sixth embodiment of the present invention, alignment marks formed on a substrate are photographed and the beam position of an exposure beam is detected on an exposure surface. Since exposure of the desired image is performed on the photosensitive material based on these, the exposure image can be exposed on the exposure surface with a high degree of position accuracy.

The seventh embodiment of the present invention is a calibration method for an exposure device. In this calibration method, a standard mark that is an exposure position standard provided on a photosensitive material is read by a reading unit that is movable in a direction intersecting the scanning direction of the photosensitive material. Exposure position adjustment is performed on the photosensitive material based on the obtained standard position data, and calibration of the exposure position adjustment function of the exposure device, which exposes the photosensitive material with light beams modulated in accordance with image data while moving the photosensitive material in the scanning direction with a moving unit, is performed. Prior to reading the standard mark with the reading unit, a calibration component, provided with multiple calibration standard marks arranged at preset intervals along the moving direction of the reading unit, is set in a position where reading by the reading unit is possible. At least one of the multiple calibration standard marks is read by the reading unit set in a position to read the standard marks, calibration data is calculated based on the position data obtained by the reading of the reading unit, and calibration of the exposure position adjustment function of the exposure device is performed by making the standard position data reflect the calibration data.

With the seventh embodiment of the present invention, the exposure position adjustment function of the exposure device is calibrateed. In order to do this, prior to reading a standard mark that is an exposure standard provided on a photosensitive material, a calibration component provided with multiple calibration standard marks arranged at preset intervals along the moving direction of a reading unit is placed in a position that is readable for the reading unit. The reading unit, placed in a position to read the above-described standard mark, reads a standard mark from among the multiple calibration standard marks. Calibration data is calculated based on the position data of the reading unit obtained by this reading. For example, in the case where the reading unit is a photographing device, the calibration data is calculated based on data such as position deviation data of the photographing optical axis (lens optical axis) and the calibration standard mark. That calibration data is reflected in the standard position data. Due to this, calibration of the exposure position adjustment function, whose accuracy is adversely affected by position changes accompanying movement of the reading unit, is possible. The accuracy of corrections of deviation in exposure position relative to the photosensitive material can be improved.

The exposure device and calibration method therefor of the present invention are configured as described above, so calibration of the exposure position adjustment function, whose accuracy is adversely affected by position changes accompanying movement of the alignment camera used for photographing the alignment marks of the photosensitive material. The accuracy of corrections of deviation in exposure position relative to the photosensitive material can be improved.

Further, with the exposure device and exposure method of the present invention, alignment marks formed on a substrate are photographed and exposure beam positions on the exposure surface are detected and, based on this, exposure of the desired image on the photosensitive material can be performed and an exposure image can be exposed on a substrate with a high degree of position accuracy.

### BRIEF DESCRIPTION OF THE DRAWINGS

Embodiments of the present invention will be described in detail based on the following figures.

FIG. 1 is a perspective view of an exposure device in one embodiment of the present invention;

FIG. 2 is a perspective view of the structure of a scanner in one embodiment of the present invention;

FIG. 3 is an outline block diagram of an optical system of an exposure head in one embodiment of the present invention;

FIG. 4A is a plan view showing the scanning tracks of the exposure light beams of each micro-mirror when the DMD is not at an incline in the exposure device in a first embodiment of the present invention;

FIG. 4B is a plan view showing the scanning tracks of the exposure light beams when the DMD is inclined;

FIG. 5 is a partially enlarged view illustrating the structure of the DMD provided in an exposure device in one embodiment of the present invention;

FIGS. 6A and 6B are explanatory diagrams explaining the motions of the DMD shown in FIG. 5;

FIG. 7 is a perspective view of the structure of an alignment unit in one embodiment of the present invention;

FIG. 8 is a plan view of a standard board in one embodiment of the present invention;

FIG. 9A is an explanatory diagram of a state where detection slits are used for detecting lit specified pixels and pixels surrounding light in an exposure device in one embodiment of the present invention;

FIG. 9B is an explanatory diagram of a signal when a photosensor has detected lit specified pixels;

FIG. 10 is a block diagram of the general structure of an electrical system of a controller provided in an exposure device in one embodiment of the present invention;

FIGS. 11A through 11D are explanatory diagrams showing the connections between a photographing view of a CCD camera and detection marks when photographing a camera position detection unit of an embodiment of the present invention;

FIG. 12 is a flowchart showing the flow of the control contents of a camera calibration operation performed in an exposure device in one embodiment of the present invention;

FIG. 13 is a flowchart showing the flow of the control contents of obtaining a position connection between an exposure standard and the center of a camera optical axis as performed in an exposure device in one embodiment of the present invention;

FIG. 14 is a flowchart showing the flow of the control contents of an operation for obtaining the position relations of an exposure standard and a camera calibration standard performed in an exposure device in one embodiment of the present invention;

FIG. 15 is a plan view showing a modified example of a camera position detection unit.

FIGS. 16A through 16D are explanatory diagrams showing another modified example of a camera position detection unit and the connection between a photographing field of view and detection marks when photographing the camera position detection unit with a CCD camera.

FIG. 17 is a diagram showing an angle measurement method for a standard board and exposure head of one embodiment of the present invention.

FIG. 18 is a diagram showing a method for obtaining the position relations of an exposure standard and a camera calibration standard performed in an exposure device in one embodiment of the present invention.

### DETAILED DESCRIPTION OF THE INVENTION

Hereafter, the exposure device of the embodiments of the present invention will be explained while referring to the drawings.

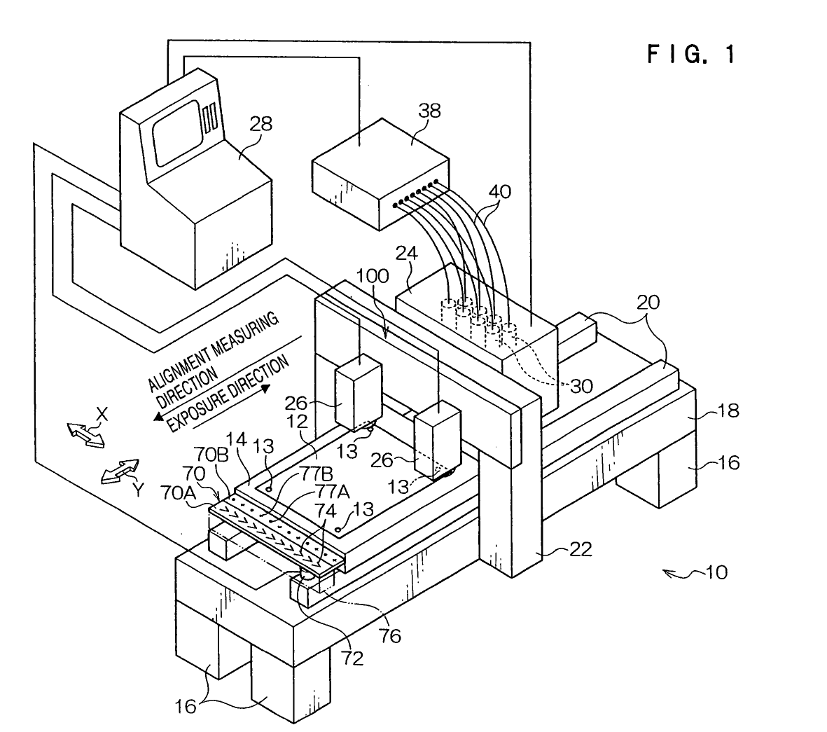

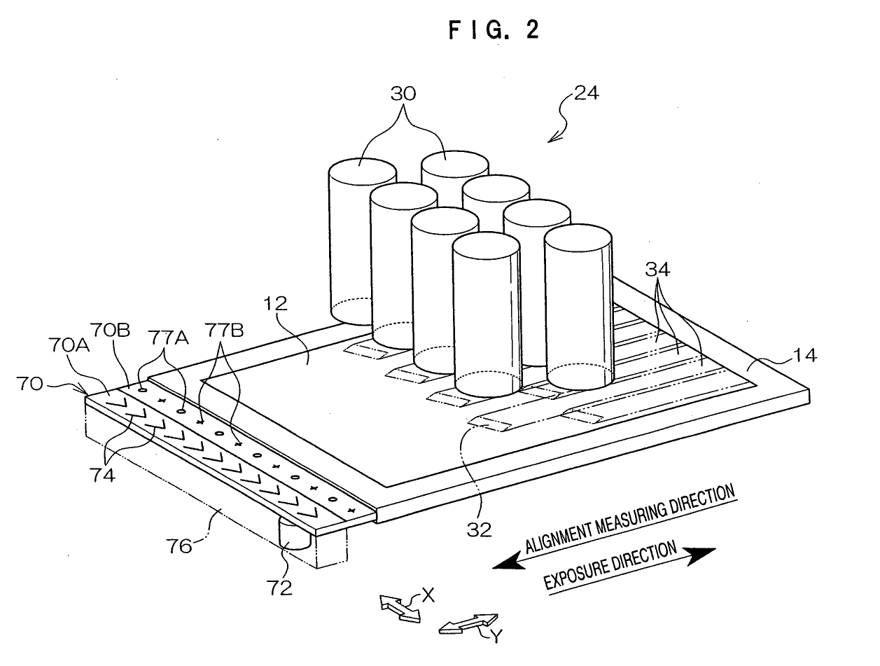

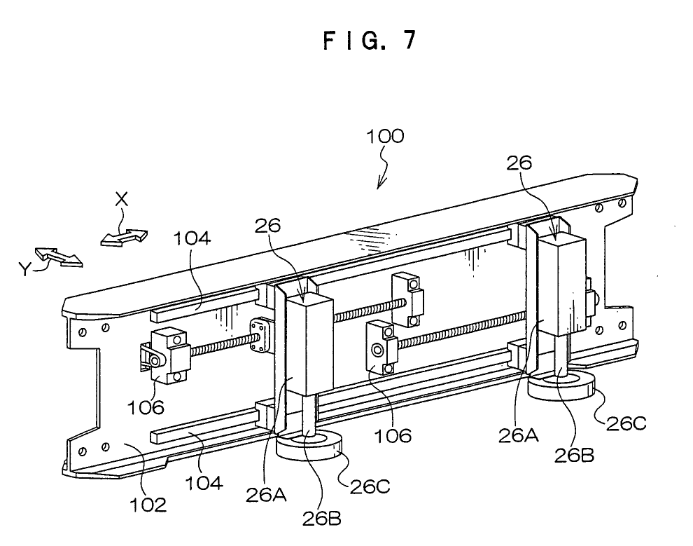

An embodiment of the exposure device of the present invention is illustrated in FIG. 1. Further, FIGS. 2 through 6 show an exposure head and SLM elements applied to embodiments of the present invention, and FIG. 7 shows an alignment unit as applied to an embodiment of the exposure device of the present invention.

As shown in FIG. 1, the exposure device 10 is equipped with a rectangular thick placement mount 18 supported by four legs 16. The upper surface of the placement mount 18 has two guides 20 extending in the lengthwise direction, and a rectangular stage 14 is provided on the two guides 20. The stage 14 forms the moving structure and is set to face the extending lengthwise direction of the guides 20, being supported such that it can move back and forth on the placement mount 18 via the guides 20. The stage 14 is driven by a drive mechanism (not shown) and moves back and forth along the guides 20 in the Y-direction shown in FIG. 1.

A rectangular board-shaped photosensitive material 12, which is the object to be exposed, is mounted on the upper surface of the stage 14 in a set position state where a predetermined mounting position is set by a set position portion (not shown). Multiple groove portions (not shown) are formed on the upper surface of the stage 14 (i.e., the photosensitive material mounting surface). The groove portions exhibit negative pressure due to a negative pressure source, whereby the photosensitive material 12 is sucked and retained to the upper surface of the stage 14. Further, the photosensitive material 12 is provided with multiple alignment marks 13 showing the standard exposure position. In the present embodiment, a total of four alignment marks 13 composed of circular through-holes are each arranged in the vicinity of one of the four corners of the photosensitive material 12.

A U-shaped gate 22 is set in the center portion of the placement mount 18 such that it straddles the path of movement of the stage 14. Each end portion of the gate 22 is fixed to a surface on each side of the placement mount 18. The gate 22 is sandwiched between, on one side, a scanner 24 that exposes the photosensitive material 12, and on the other side, an alignment unit 100 provided with multiple (e.g., two) CCD cameras 26 for photographing the alignment marks 13 provided on the photosensitive material 12.

As shown in FIG. 7, the alignment unit 100 is provided with a rectangular unit base 102 that attaches to the gate 22. The side of the unit base 102 surface that houses the cameras also has guide rails 104 extending in a direction (X-direction arrow) perpendicular to the movement direction of the stage 14 (Y-direction arrow). Each CCD camera 26 is set so as to be slidably guided by this set of guide rails 14, and each CCD camera 26 also has its own individually provided ball screw mechanism 106 and a drive source such as a stepping motor (not shown) that drives the ball screw mechanism 106. The CCD cameras 26 thus independently move in a direction perpendicular to the movement direction of the stage 14. Further, each CCD camera 26 has a lens unit 26B attached to the end of a camera body 26A and facing downward. Each CCD camera is positioned so that the optical axis of the lens is substantially perpendicular to the X-direction, and a ring-shaped strobe light 26C (i.e., LED strobe light source) is attached to the end portion of the lens unit 26B.

The CCD cameras 26, when photographing the alignment marks 13 of the photosensitive material 12, are moved by the above-mentioned drive sources and ball screw mechanisms 106 in the direction of the X-arrow, where each is set at preset photographing positions. In other words, the lens optical axis is arranged to match the passing positions of the alignment marks 13 of the photosensitive material 12, which moves with the stage 14. Once the alignment marks 13 reach a predetermined photographing position, the strobe light 26C emits light. The strobe light is irradiated on the photosensitive material 12 and the light that reflects off the upper surface of the photosensitive material 12 is inputted into the camera body 26A through the lens unit 26B, whereby the alignment mark 13 is photographed.

Further, the drive device of the stage 14, the scanner 24, the CCD camera 26, and the drive source that moves the CCD camera 26 are all connected to a controller 28 that controls them. The controller 28 controls the stage 14 to move at a preset speed during the exposure process of the exposure device 10 (this action will be explained hereafter). The CCD camera 26, which is set in a predetermined position, is controlled such that it photographs the alignment mark 13 of the photosensitive material 12 at preset timing. The scanner 24 is controlled such that it exposes the photosensitive material 12 at preset timing.

As shown in FIG. 2, multiple exposure heads 30 (e.g., eight heads) are set within the interior of the scanner 24. These are arranged to form an approximate matrix, with m rows and n columns (e.g., two rows of four columns).

The exposure areas 32, which are exposed by the exposure heads 30, are formed such that, for example, shortening the scanning direction to the short side. In this case, with the moving motion of the scanning exposure, a belt-shaped exposed region 34 is formed at each exposure head 30.

Also as shown in FIG. 2, each line of exposure heads 30, which are all set into rows, are arranged such that the belt-shaped exposed regions 34 line in a direction perpendicular to the scanning direction with no spaces between them. Each of the exposure heads 30 are arranged in staggered formation with preset spaces between them in the direction of the row (i.e., times the natural number of the long side of the exposure area). If, for example, there is a portion that cannot be exposed in the exposure areas 32 of the first row, this configuration ensures that it will be exposed in the exposure areas 32 of the second row.

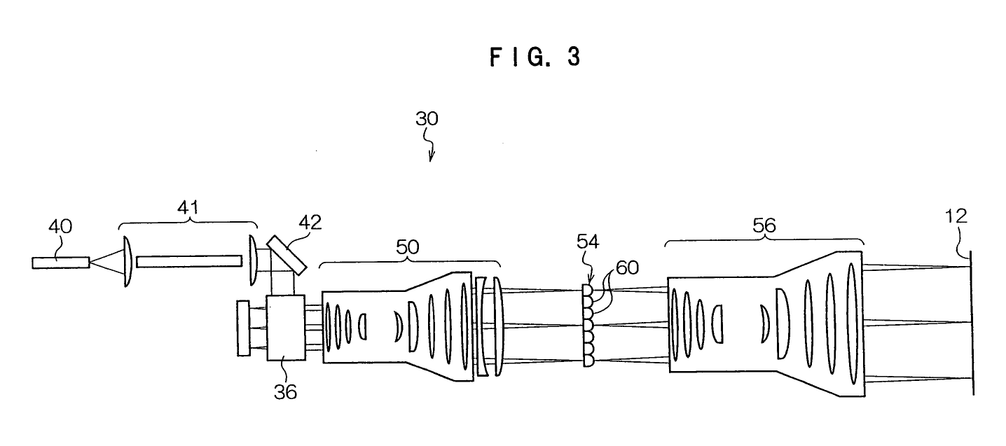

As shown in FIG. 3, each exposure head 30 is provided with a DMD 36, which acts as an SLM element that modulates incident light entering the exposure head to each pixel in accordance with image data. The DMD 36 is connected to the above-described controller 28 provided with a data processing unit and a mirror drive control unit.

The data processing unit of the controller 28 generates a control signal to each exposure head 30 based on the inputted image data. The control signal controls the driving of each micro-mirror within the region of the DMD 36 that should be controlled. Details on the region that should be controlled will be provided later. The mirror drive control unit, which acts as the DMD controller, controls the angles of the reflective surfaces of each micro-mirror in the DMD 36 of each exposure head 30. Details regarding the angle control of the reflective surfaces will be provided hereafter.

The DMD 36 of each exposure head 30 has an incident light side from which light enters. As seen in FIG. 1, a lighting device 39 emits multi-beams, which extend in a direction and include ultraviolet rays, as laser light. Each bundled optical fiber 40 extending from the lighting device 38 is connected to each exposure head 30.

Drawings of the lighting device 38 have been omitted, however, the interior thereof is equipped with multiple light wave integrating modules that integrate the light waves of lasers emitted from multiple semiconductor laser chips and input them into the optical fibers. The optical fibers extending from each integrating module are integrating optical fibers that propagate integrated laser light. The multiple optical fibers are grouped into one bundle, which forms the optical fiber 40.

As shown in FIG. 3, in each exposure head 30, the side of the DMD 36 from which light enters is provided with a uniform illumination optical system 41 that makes the illuminated light uniform. This side of the DMD also has a mirror 42 that reflects the laser that passes through the uniform illumination optical system 41 towards the DMD 36.

The projection optical system provided at the light-reflecting side of the DMD 36 in each exposure head 30 projects an image of the light source onto the photosensitive material 12, which is on the exposure surface of the light-reflecting side of the DMD 36. Accordingly, the optical system has optical elements for exposure in the following order from the DMD 36 to the photosensitive material 12: a lens system 50, a micro-lens array 54, and an objective lens system 56.

As shown in FIG. 3, the lens system 50 and objective lens system 56 are enlarged optical systems with combinations of multiple lenses (concave and convex lenses). By enlarging the cross-sectional area of the laser beams (bundle of rays) reflected by the DMD 36, the area of the exposure area 32 on the photosensitive material 12 is enlarged to a predetermined size with the laser beams reflected by the DMD 36. The photosensitive material 12 is arranged at a backward focal position of the objective lens system 56.

As seen in FIG. 3, the micro-lens array 54 has multiple micro-lenses 60. The irradiated laser light, coming from the lighting device 38 and passing through each optical fiber 40, is reflected by each micro-mirror 46 of the DMD 36. The multiple micro-lenses 60 are arranged two-dimensionally and these correspond on a one-to-one basis with each micro-mirror 46 of the DMD 36. The micro-lens array 54 is what the micro-lenses 60 are formed uniformly in a rectangular plate shape, and each micro-lens 60 is disposed on the optical axis of each laser beam (exposure beam) that passes through each respective lens system 50.

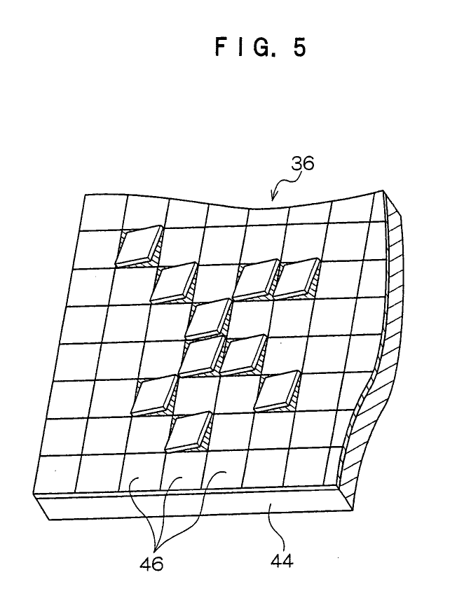

As shown in FIG. 5, the DMD 36 comprises an SRAM cell 44 (memory cell) on which micro-mirrors 46 (ultra-small mirrors) are arranged and supported. It is a mirror device on which a large number of micro-mirrors (e.g., 600 by 800) formed from pixels are arranged in a lattice shape. The surface of each micro-mirror 46 has a highly reflective substance such as aluminum vapor-deposited thereon.

Further, directly underneath the micro-mirror 46 is a support including a hinge and a yoke (not shown). The SRAM cell 44 of the CMOS silicon gate manufactured at a manufacturing line of a regular semiconductor memory supports each micro-mirror 46 and the entire device is configured monolithically (i.e., with an integrated or unified form).

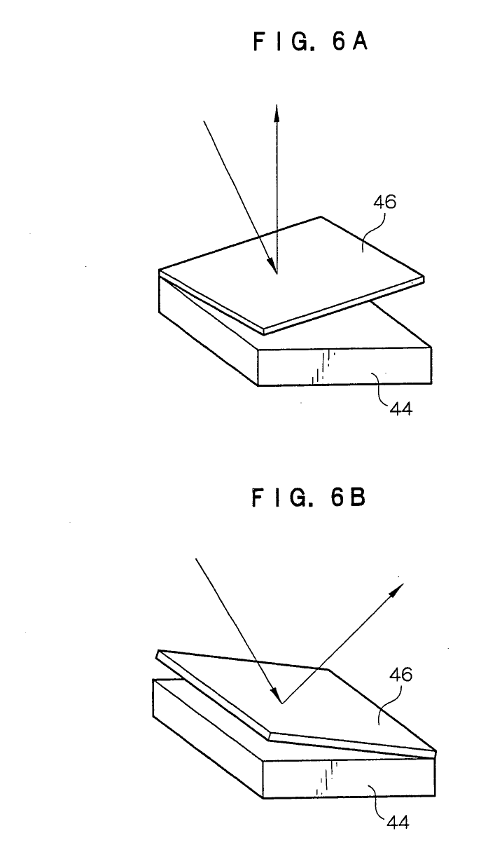

When a digital signal is written to the SRAM cell 44 of the DMD 36, the micro-mirror 46, supported by the support, tilts at a range of ±α degrees (e.g., 10°) relative to the base on which the DMD 36 is arranged with the diagonal line as reference. FIGS. 6A and 6B, in which a portion of the DMD 36 has been enlarged, show one example where the micro-mirror 46 is in a state controlled to be at +α° or −α°. FIG. 6A shows the micro-mirror 46 inclined at +α°, which is an on-state, and FIG. 6B shows the micro-mirror 46 inclined at −α°, which is an off-state. Accordingly, the inclination of the micro-mirror 46 in each pixel of the DMD 36 is controlled in response to image signals, as shown in FIG. 6. The incident light coming to the DMD 36 is thus reflected in the tilted direction of each respective micro-mirror 46.

On/off control of each respective micro-mirror 46 is performed by the mirror drive-control unit of the controller 28 connected to the DMD 36. The light reflected by the micro-mirror 46 in the on-state is modulated to an exposure condition and input to the projection optical system provided at the light outputting side of the DMD 36 (refer to FIG. 3). Further, light reflected by the micro-mirror 46 in the off-state is modulated to a non-exposure condition and input to a light-absorption body (not shown).

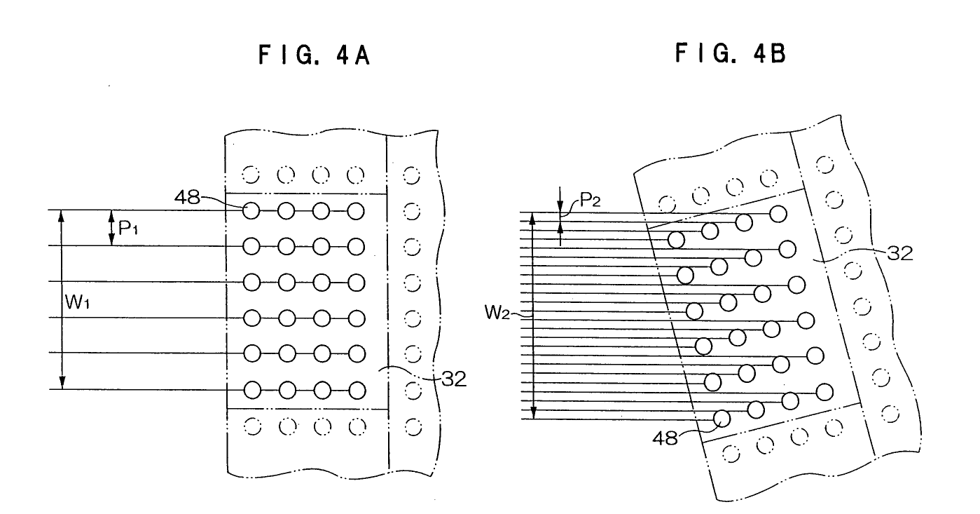

The DMD 36 may be arranged at a slight slant or incline such that the direction of the short side forms a preset angle (e.g., 0.1° to 0.5°) with a scanning direction. FIG. 4A shows the scanning trajectory of a reflected light image (exposure beam) 48 of each micro-mirror when the DMD 36 is not at a slant. FIG. 4B shows the scanning trajectory of the exposure beams 48 when the DMD 36 is slanted.

The DMD 36 has many micro-mirrors 46 (e.g., 800) arranged in a row in the longitudinal direction (direction of movement) and in the short direction, many sets of micro-mirrors (e.g., 600 sets) are arranged. As seen in FIG. 4B, by inclining or tilting the DMD 36, the pitch P₂ of the scanning trajectory (scanning line) of the exposure beam 48 from the micro-mirror 46 becomes narrower than the pitch P₁ of the scanning line when the DMD 36 is not tilted, whereby resolution is greatly improved. Meanwhile, the angle of inclination of the DMD 36 is extremely minute, accordingly, the scanning width W₂ when the DMD 36 is tilted and the scanning width W₁ when the DMD 36 is not tilted are roughly the same.

Moreover, the substantially same positions (dots) in the same scanning line become re-exposed (i.e., multiple exposure) by different rows of micro-mirrors. By performing such multiple exposure, the exposure positioning can be minutely controlled thereby achieving high-resolution exposure. Further, by minutely controlling the exposure positions, the connecting portions between multiple exposure heads arranged in the scanning direction can be connected without any gaps between them.

It should be noted that in place of tilting or placing the DMD 36 at an incline, the same effect can be obtained by arranging each row of micro-mirrors, in a direction perpendicular to the scanning direction, in staggered formation with preset gaps between them.

The exposure device 10 of the present embodiment has, as shown in FIGS. 1 and 2, an irradiated beam position and a detection unit, which detects the amount of light and gaps in the aforementioned position. These are arranged on the downstream side of the alignment measuring direction in the moving direction (direction of Y-arrow) of the stage 14 (i.e., the upstream side of the exposure direction). This detection unit is equipped with a standard board 70 attached to the edge portion of the stage 14 at the downstream side in the alignment measuring direction, and a photosensor 72, which is movably attached to the reverse side of the standard board 70.

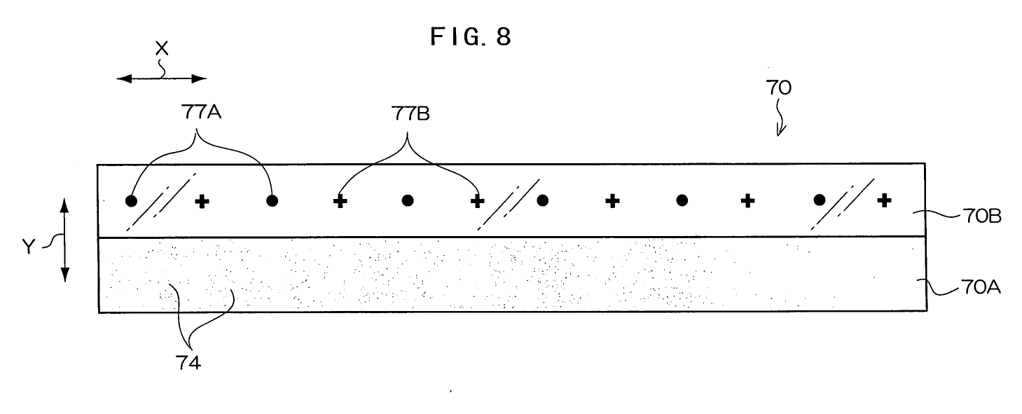

The standard board 70 is formed of a rectangular glass board having a length equivalent to the entire widthwise length of the stage 14. A beam position detection unit 70A is provided on the downstream side of the alignment measuring direction of the stage 14, and a camera position detection unit 70B is provided upstream of the beam position detection unit 70A (refer to FIG. 8).

The beam position detection unit 70A has multiple transparent arrow-shaped detection slits 74 that are patterned with a metal film such as chrome plating. The detection slits 74 are arranged at preset intervals along the X direction.

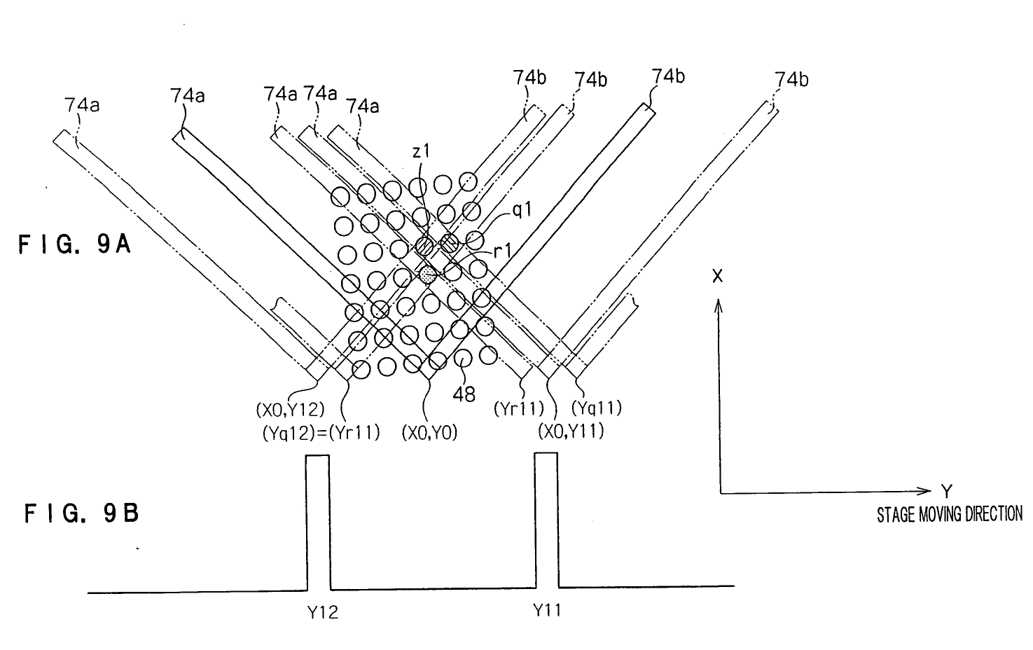

As shown in FIG. 9A, the arrow-shaped detection slits 74 are formed from straight-lined first slit portions 74a and straight-lined second slit portions 74b. One end of each of these are connected perpendicularly, thus forming the detection slit 74. The first slit portion 74a, which has a preset length, is positioned upstream of the stage movement direction, whereas the second slit portion 74b, which also has a preset length, is positioned downstream thereof. Specifically, the first slit portions 74a and the second slit portions 74b perpendicularly intersect each other. Relative to the Y axis, the first slit portions 74a has the angle of 135° and the second slit portions 74b has the angle of and 45°.

The first slit portion 74a and second slit portion 74b in the detection slit 74 have been illustrated such that they form 45° angles relative to the moving direction of the stage 14 (i.e., scanning direction). Nonetheless, if the first slit portion 74a and second slit portion 74b can be set at an inclined state (i.e., a state where they are arranged so as to not be parallel to each other) relative to the moving direction of the stage while simultaneously being inclined relative to the pixel rows of the exposure head 30, their respective angles relative to the moving direction of the stage can be optionally set. Further, a diffraction grid can be used in place of the detection slit 74.

Beneath the detection slits 74 in the beam position detection unit 70A, the photosensor 72 (a device such as a CCD, CMOS, or photodetector) which detects light from the exposure head 30, and a moving device 76, which operates and moves the photosensor 72, are arranged. The moving device 76 is driven and controlled by commands from the controller 28. The moving device 76 moves the photosensor 72 along the X-direction with a transporting unit such as a linear motor transport system, a screw transport system, or a transport belt. The moving device 76 is configured such that it stops the photosensor 72 at each predetermined position. The moving device 76 moves the photosensor 72 to predetermined positions directly underneath each detection slit 74 in the beam position detection unit 70A and stops it under each one.

As illustrated in FIG. 8, the camera position detection unit 70B has detection marks 77A and 77B, which are patterned with a metal film such as chrome plating. Multiple detection marks 77A, which are formed in circular shapes, and multiple detection marks 77B, which are formed in cross shapes, are alternately arranged at preset intervals along the X-direction.

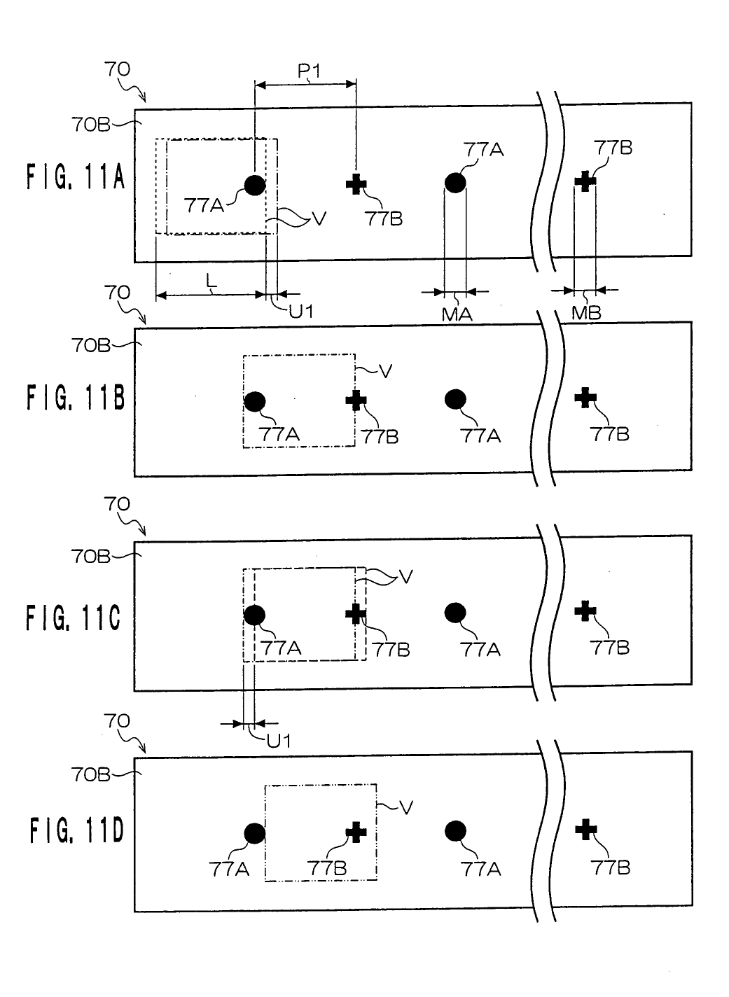

As shown in FIGS. 11A to 11D, the width measurement MA of the detection mark 77A is equal to the width measurement MB of the detection mark 77B, such that MA=MB. The distribution pitch P1 of detection marks 77A and 77B is equal to a set value where ½ the width measurements of the detection marks 77A and 77B are deducted from the length measurement L of the CCD camera 26 view V (photographing range of vision) in the X direction (P1=L−(MA/2)=L−(MB/2)). Further, the movement unit U1 of the CCD camera 26 in the X direction is set at ½ the width measurements of the detection marks 77A and 77B (U1=MA/2=MB/2).

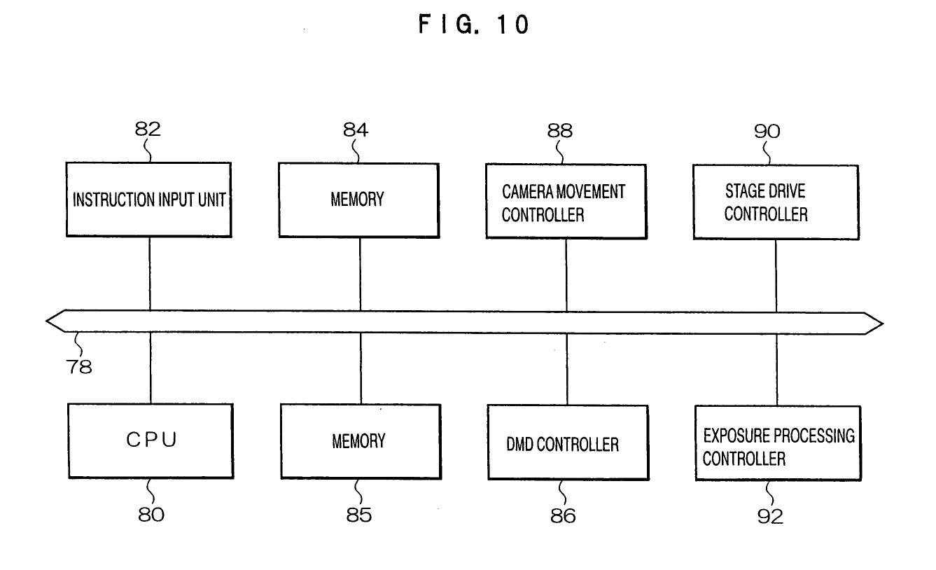

Next, the outline structure of the electrical system used for control in the controller 28 provided in the exposure device 10 of the present embodiment will be explained while referring to the block diagram in FIG. 10.

The electrical system used for control in the controller 28 is configured such that all of the following components are connected through a bus 78: a CPU 80 that functions both as a main control unit that integrates control of each part of the device, and as the aforementioned data processing unit; an instruction input unit 82 having switches installed in the controller 28 that the operator uses to input commands; a memory 84 that temporarily stores items such as image data; a memory 85 that stores calibration data that will be described later; a DMD controller 86 that functions as a mirror drive control unit that controls each micro mirror 46 in each DMD 36; a camera movement controller 88 that controls driving of the drive source (e.g., stepping motor) to move each CCD camera 26; a stage drive controller 90 that controls the negative pressure source, which generates negative pressure within the groove portions on the upper surface of the stage 14 on which the photosensitive material 12 is mounted, and devices such as a drive device, which moves the stage 14 in the scanning direction; and an exposure processing controller 92 that controls devices that are necessary for performing exposure processing in the exposure device 10, such as the lighting device 38.

When performing exposure processing with the above-described control electrical system, the operator operates the instruction input unit 82 of the controller 80 to input, for example, instructions for image data that will be processed for exposure. Next, the image data that has been conveyed to the CPU 80 is stored once in the memory 84. Exposure processing is performed by instructing the initiation of image processing so that the DMD controller 86 is controlled to perform formation processing of an image based on the image data read out from the memory 84; and by controlling devices such as the stage drive controller 90 that drives the stage, the exposure processing controller 92 that controls exposure processing, and the lighting device 38.

Next, the process regarding detection of the beam positions irradiated from each exposure head 30 of the scanner 24 provided in the exposure device 10 will be explained. Further, the process behind specifying the actual position of one particular pixel z1 (hereafter, “pixel z1”) of the DMD 36 when the pixel is illuminated (i.e., when a specified pixel is on) will also be explained. This method, in which the actual position of a lit or illuminated pixel z1 is specified and the amount of light of the pixel z1 is detected, can be used for confirmation of items such as the state of correctness of the pixel z1 and the initial conditions.

First, when the operator operates the instruction input unit 82 of the controller 28 and inputs instructions to specify the actual position of the illuminated pixel z1, those instructions are received by the CPU 80. The CPU 80 operates and moves the stage 14 so that a predetermined detection slit 74 used in a predetermined exposure head 30 of the standard board 70 is positioned underneath the scanner 24.

Next, the CPU 80 outputs a control signal to the DMD controller 86 and the exposure processing controller 92, and performs control such that only the pixel z1 in a preset DMD 36 is in an illuminated state. Further, the CPU 80 outputs a control signal to the stage drive controller 90 and moves the stage 14, as shown in the solid lines in FIG. 9A, such that the detection slit 74 is at a preset position on the exposure area 32 (e.g., the position that should act as the origin). At this time, the CPU 80 recognizes the intersecting point (X0, Y0) of the first slit portion 74a and second slit portion 74b and stores it in the memory 84. In FIG. 9A, the direction rotating counterclockwise to the Y-axis is a positive angle.

Next, as shown in FIG. 9A, the CPU 80 begins moving the detection slit 74 to the right along the Y-axis by outputting a control signal to the stage drive controller 90 and moving the stage 14. Then, as seen in the example shown in FIG. 9B, when the detection slit 74 detects that the photosensor 72 has detected the light from the illuminated pixel z1 that passed through the first slit portion 74a, the CPU 80 outputs a control signal to the stage drive controller 90 and stops the stage 14. The CPU 80 recognizes that intersecting point (X0, Y11) of the first slit portion 74a and second slit portion 74b and stores it in the memory 84.

Next, the CPU 80 outputs a control signal to the stage drive controller 90 and moves the stage 14, and initiates movement of the detection slit 74 to the left along the Y-axis, as shown in FIG. 9A. Then, as seen in the example shown in FIG. 9B, when the detection slit 74 detects that the photosensor 72 has detected the light from the illuminated pixel z1 that passed through the second slit portion 74b at a position to the left of the predetermined position shown with an imaginary line in FIG. 9B, the CPU 80 outputs a control signal to the stage drive controller 90 and stops the stage 14. The CPU 80 recognizes that intersecting point (X0, Y12) of the first slit portion 74a and second slit portion 74b and stores it in the memory 84.

The CPU 80 reads out the coordinates (X0, Y11) and (X0, Y12) stored in the memory 84, requests the coordinates of the pixel z1, and specifies the actual position. Here, if the pixel z1 coordinates are (X1, Y1) then X1=X0+(Y11−Y12)/2 and Y1=(Y11+Y12)/2.

When the detection slit 74, which has the first slit portion 74a intersecting with the second slit portion 74b, is used in combination with the photosensor 72, the photosensor 72 only detects light of a specific range that passes through the first slit portion 74a or the second slit portion 74b. For this reason, it is not necessary for the photosensor 72 to have a refined special configuration that detects the amount of light of only a narrow range corresponding to the first slit portion 74a or the second slit portion 74b. In other words, some other reasonably priced and commercially available photosensors can be used.

Next, exposure of the photosensitive material 12 with the exposure device 10 configured as discussed above will be explained.

First, when image data complying with an exposure pattern is inputted into the controller 28, this data is stored once in the memory 84 of the controller 28. This image data represents the density of each pixel that forms an image as binary values (existence of dot storage).

Next, the photosensitive material 12 is set on the stage 14, and the operator performs input operation of exposure commencement from the instruction input unit of the controller 28. Examples of the photosensitive material 12 on which image exposure is performed with the exposure device 10 include a substrate or a glass plate, which form a pattern (image exposure) of a print wiring substrate and LCD element, and having photoresist such as a photosensitive epoxy resin applied thereon. Or, when using dry film, a laminated material can be used.

With the above inputting operation, the exposure operation of the exposure device 10 begins and the drive device is controlled by the controller 28. The stage 14, which has the photosensitive material 12 sucked and held by its upper surface, begins moving in the moving direction (direction of Y-arrow) at a constant speed along the guides 20 from the upstream side to the downstream side of the alignment measuring direction. Each CCD camera 26 is controlled by the controller 28 to operate at a timing corresponding to the commencement of stage movement or slightly prior to the edge of the photosensitive material 12 reaching directly below each CCD camera 26.

With the movement of the stage 14, alignment measurement is performed with the CCD camera 26 when the photosensitive material 12 passes underneath the CCD camera 26.

This alignment measurement first involves each CCD camera 26 photographing its respective alignment mark 13. This is performed at preset timing when two alignment marks 13 set in the vicinity of the corners of the downstream side of the movement direction (the anterior side) of the photosensitive material 12 reach directly beneath each CCD camera 26 (on the optical axis of the lens). This photographed image data, namely, the image data that is the exposure position standard data and includes standard position data designated by the alignment marks 13, is outputted to the CPU 80, which is the data processing unit of the controller 28. Once the alignment marks 13 have been photographed, movement of the stage 14 towards the downstream direction recommences.

Moreover, in cases where the photosensitive material has, as with the photosensitive material of the present embodiment, multiple alignment marks 13 set along the movement direction (scanning direction) the next alignment marks 13 (i.e., the two set in the vicinity of the corners upstream of the movement direction, that is, towards the posterior side of the material) reach directly beneath each CCD camera 26. Once this occurs, each CCD camera 26 photographs its respective alignment mark 13 at preset timing and outputs the image data to the CPU 80 of the controller 28, similar to the above-described process.

The same is true for when the photosensitive material has three or more alignment marks provided along the movement direction. As each alignment mark passes underneath the CCD camera 26, photographing by the CCD camera 26 is repeated at preset timing and the photographed image data of all of the alignment marks is outputted to the CPU 80 of the controller 28.

The CPU 80 performs calculating processing on the mark positions within an image ascertained from the inputted image data of each alignment mark 13 (standard position data) and the pitch between the marks, as well as on the position of the stage 14 at the time of photographing the alignment marks 13 in question and the position of the CCD camera 26. By these calculations, the CPU 80 obtains condition information such as deviations in the mounting position of the photosensitive material 12 on the stage 14, deviations in inclination of the photosensitive material 12 relative to the movement direction, and precision errors in measurement of the photosensitive material 12, and calculates the correct exposure position relative to the surface of the photosensitive material 12 to be exposed. Next, when image exposure is performed with the scanner 24 (described hereafter) a control signal is generated based on the image data of the exposure pattern stored in the memory 84, the control signal having the correct exposure position adjusted and incorporated therein, whereby correction control (alignment) for image exposure is executed.

When the photosensitive material 12 passes underneath the CCD camera 26, alignment measurement with the CCD camera 26 is completed and the stage 14 continues to be driven by the drive device in the opposite direction, thus moving along the guides 20 towards the exposure direction. The photosensitive material 12, with the movement of the stage 14, moves underneath the scanner 24 and towards the downstream side of the exposure direction. Once the image exposure regions of the surface to be exposed reaches an exposure commencement position, each exposure head 30 of the scanner 24 irradiates beams of light, thus beginning image exposure of the surface of the photosensitive material 12 to be exposed.

Here, the image data stored in the memory 84 of the controller 28 is gradually read out in portions of multiple lines, and control signals are generated to each exposure head 30 based on the image data read out at the CPU 80 functioning as the data processing unit. Corrections for exposure position deviations of the alignment-measured photosensitive material 12 obtained from the above-described correction control (alignment) are included in the control signals. The DMD controller 86, which functions as the mirror drive control unit, controls the on/off of each of the micro-mirrors 46 in the DMD 36 in each exposure head 30, based on the generated and corrected control signal.

When the laser light outputted from the optical fiber 40 of the lighting device 38 is irradiated to the DMD 36, the reflected laser light, when the micro-mirrors of the DMD 36 are on, goes through the lens system including each micro-lens 60 corresponding to the micro-lens array 54, whereby an image is formed on the exposure surface of the photosensitive material 12. In this manner, the laser light outputted from the lighting device 38 is turned on or of by each pixel, and the photosensitive material 12 is exposed with the pixel units (exposure area) of substantially the same number as the number of pixels used by the DMD 36.

Further, the photosensitive material 12 is moved with the stage 14 at a constant speed, whereby the photosensitive material 12 is scanned by the scanner 24 in the movement direction and the opposite direction. Belt-shaped exposed regions 34 (as seen in FIG. 2) are thus formed by each exposure head 30.

Once image exposure of the photosensitive material 12 is completed with the scanner 24, the stage 14 is driven by a drive device as is towards the downstream side of the exposure direction. The stage 14 returns to the origin at the furthest downstream side of the exposure direction (i.e., the side furthest upstream of the alignment measurement direction) whereby exposure of the photosensitive material 12 with the exposure device 10 is completed.

Hereafter, the calibration method of the alignment function (exposure position adjustment function) in the exposure device 10 of the present embodiment will be explained.

In the exposure device 10 of the present embodiment equipped with the aforementioned alignment function, the positioning of the CCD camera 26 changes with the movement of the above operation thus causing rolling, pitching, and yawing. Since there are cases where the center of the optical axis of the photographing lens, set in the photographing position, shifts or deviates from the normal position, even if correction of the exposure position and image exposure are performed using the alignment function, the photographing can cause exposure position deviation that exceeds allowable limits.

In order to calibrate the alignment function where the precision is adversely affected by the optical axis deviation factor caused by the positioning change of the CCD camera 26, calibration of the alignment function is executed. This is performed with a calibration method, explained below, which can be put into practice when, for example, the exposure device 10 is being manufactured or having maintenance performed thereon.

Regarding the process of the calibration operation, first calibration of the CCD camera 26 is performed and then the relation of the positions of the exposure standard and the center of the camera's optical axis is obtained, after which the obtained information is reflected in the exposure position adjustment by the exposure head 30. This calibration operation may be performed prior to and separately from the exposure process for the photosensitive material 12, or simultaneously when exposing the photosensitive material 12. Further, regarding the calibration of the CCD camera 26 and the obtaining of the relation of the positions of the exposure standard and the center of the camera's optical axis, these can be performed sequentially or separately. Here, the process will be explained in the case where these operations are performed sequentially.

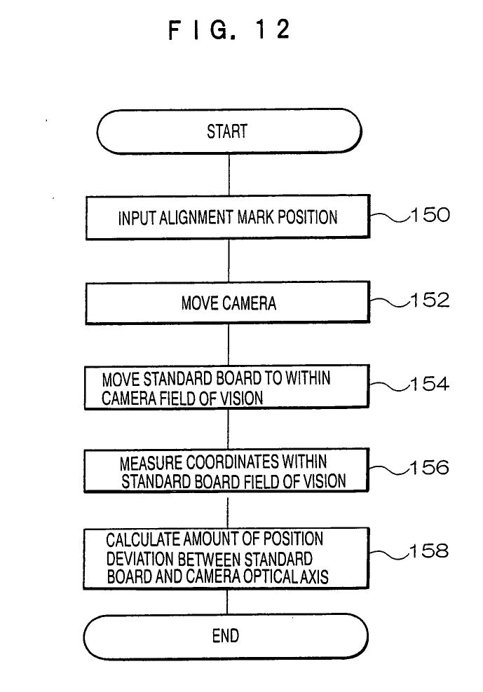

Regarding the calibration of the CCD camera 26, as shown in step 150 in FIG. 12, first the operator inputs position data for the alignment marks 13 of the photosensitive material 12, which is the object to be exposed, into the controller 28. Coordinates of the alignment marks 13 are acquired by the inputting of this position data.

Next, the calibration action of the exposure device 10 initiates when the operator performs input operation of the calibration commencement from the instruction input unit of the controller 28. In step 152, the camera movement controller 88 of the controller 28 controls the drive source for each CCD camera 26 based on the aforementioned inputted position data. Each CCD camera 26 is moved to its respective preset photographing position for photographing the alignment marks 13 of the photosensitive material 12. At this time, the position of each CCD camera 26 is controlled by the controller 28, which counts the pulses of each drive source (stepping motor). Further, this is sent in increments of the aforementioned unit of movement U1.

Once each CCD camera 26 is arranged in its alignment mark 13 photographing position, the stage 14 moves along the guides 20 from the upstream side of the alignment measuring direction to the downstream side (step 154). The stage 14 is moved until the camera position detection units 70B of the standard board 70 are set in positions beneath each CCD camera 26 (within the camera field of view).

Once the camera position detection units 70B of the standard board 70 are set within the field of vision of each CCD camera 26, each CCD camera 26 is controlled by the controller 28 and each camera position detection unit 70B is photographed. At this time, each CCD camera 26 photographs at least one of the multiple detection marks 77A and 77B arranged on the camera position detection unit 70B.

Next, in step 156, the controller 28 performs functions such as image processing in order to measure the amount of position deviation from the center of the field of vision (center of optical axis) of the photographed detection marks 77A and 77B. Here, the processing switches to image processing such as pattern matching in order to determine whether the photographed detection mark is a detection mark 77A or a detection mark 77B.

Here, the above-described pulse is used to specify which of the multiple detection marks 77A and 77B is the photographed detection mark. Further, the absolute positions of each of the detection marks 77A and 77B are measured in advance by a measuring unit and stored in the controller 28. Data on the position deviation between the standard board 70 and the center of the optical axis of each CCD camera 26 is obtained by computing the difference between this absolute position data and the above measuring result (measured value). Calibration data for correcting the amount of optical axis center deviation of each CCD camera 26 in the position of photographing the alignment mark 13 (alignment measurement position) can be obtained from the results of the above-described measurement and calculation. This calibration data is stored in the memory 85 of the controller 28 (see FIG. 10). The calibration action of the CCD camera 26 is thus completed, and the process next switches to obtaining the relation of the positions of the exposure standard and the center of the camera's optical axis.

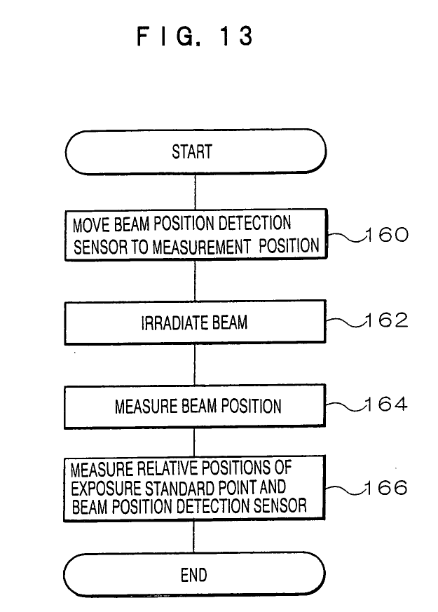

As shown in step 160 of FIG. 13, when this operation begins, the drive device is controlled by the controller 28 and the stage 14 moves the beam position detection unit 70A of the standard board 70 to the laser beam irradiation position (exposure position) of the exposure head 30. Next, in step 162, a laser beam is directed to the beam position detection unit 70A of the standard board 70 and irradiated from the exposure head 30, and the position of the exposure standard point is measured by the above-described beam position detection operation.

Here, both the beam position detection unit 70A and the camera position detection unit 70B are provided on the same standard board 70, and their position relations are measured in advance by a separate measuring section. In this manner, the position relations of the exposure standard and the detection marks 77A and 77B, which are photographed in the above-discussed camera calibration operation, are clarified. Accordingly, by calculating the exposure standard data measured in this operation and the data on the position deviation (calibration data) with the center of the optical axis of the CCD camera 26 acquired in the camera calibration operation, correction data can be obtained. This correction data, i.e., exposure standard/camera optical axis center position data (showing the position relations of the exposure standard and the center of the camera optical axis) once obtained is stored in the memory 85 of the controller 28. The obtaining of the position relations of the exposure standard and the center of the camera optical axis is then completed, thus ending the calibration operation.

Calibration of the exposure device 10 is performed by the above calibration method of the alignment function (exposure position adjustment function). When performing image exposure of the photosensitive material 12 with the calibrateed exposure device 10, the CPU 80 reads out the exposure standard/camera optical axis center position data from the memory 85. Based on the exposure pattern image data stored in the memory 84, the CPU 80 uses the exposure standard/camera optical axis center position data to calculate calibration data, which is then reflected in the generated control signal (exposure data). Next, the alignment of the photosensitive material 12 is measured as described above and the obtained correction data for the exposure position is reflected in the control signal and correction control (alignment) is further executed on this control signal, whereby the correct exposure position is adjusted and image exposure is performed.

As explained above, with the alignment function (exposure position adjustment function) calibration method of the present embodiment, in order to calibrate the alignment function of the exposure device 10, a process is executed prior to photographing the alignment marks 13 of the photosensitive material 12 with the CCD camera 26. The camera position detection unit 70B of the standard board 70 having multiple detection marks 77A and 77B arranged thereon at preset intervals along the movement direction of the CCD camera 26 (X-direction) is set in a position from which it can be photographed (within the field of vision) by the CCD camera 26. At least one of the multiple detection marks 77A and 77B is photographed by the CCD camera 26 positioned to read the alignment marks 13 provided on the photosensitive material 12. The calibration data is calculated based on the optical axis deviation data (i.e., the position data of the CCD camera 26) obtained via this photographing, and in exposing the photosensitive material 12, the calibration data is reflected in the standard position data whereby alignment is executed. By adjusting to the correct exposure position and performing image exposure, it becomes possible to calibrate the alignment function, whose precision is adversely affected by positioning movement of the CCD camera 26, thereby improving the accuracy of the correction of the exposure position deviation relative to the photosensitive material 12.

Further, in the present embodiment, the standard board 70, provided with the detection slits 74 that detect the exposure position with a laser beam, also has the beam position detection unit 70A united with the camera position detection unit 70B. Accordingly, in comparison with devices where these are separately provided, the relative positions of the detection slits 74 and the detection marks 77A and 77B can be measured with a high degree of accuracy. Furthermore, problems such as position deviation between the detection slits 74 and the detection marks 77A and 77B are less likely to occur. For this reason, if the exposure position data of the laser beam detected by the beam position detection unit 70A (and the photosensor 72) of this standard board 70 and the calibration data obtained using the camera position detection unit 70B provided in a unified manner on the standard board 70 are calculated, as long as they are the desired correction data, errors between them can be contained or controlled. By making this reflect the correction data, alignment can be performed with higher accuracy.

Further, some cases where more than one CCD camera 26 are used will make the effects of the present invention evident. When the plurality of CCD cameras 26 are used in order to reduce the reading time, the relationship of relative position of the plurality of CCD cameras are unlikely to be stable. Thus, the effects of the calibration will become more apparent. Further, the deviation of optical axis of the CCD camera 26 can be detected regarding the Y direction (FIG. 1), and thus the result of this detection may be calibrated.

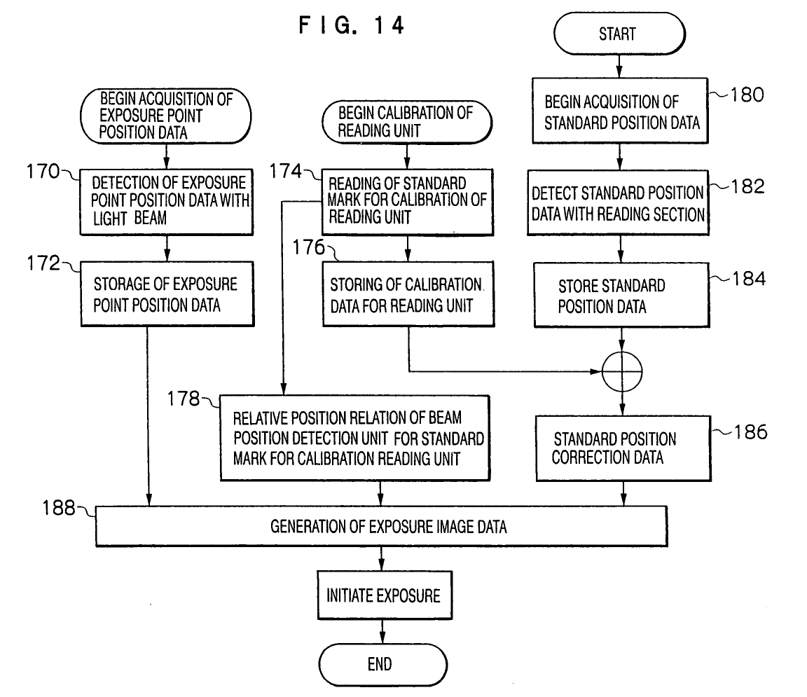

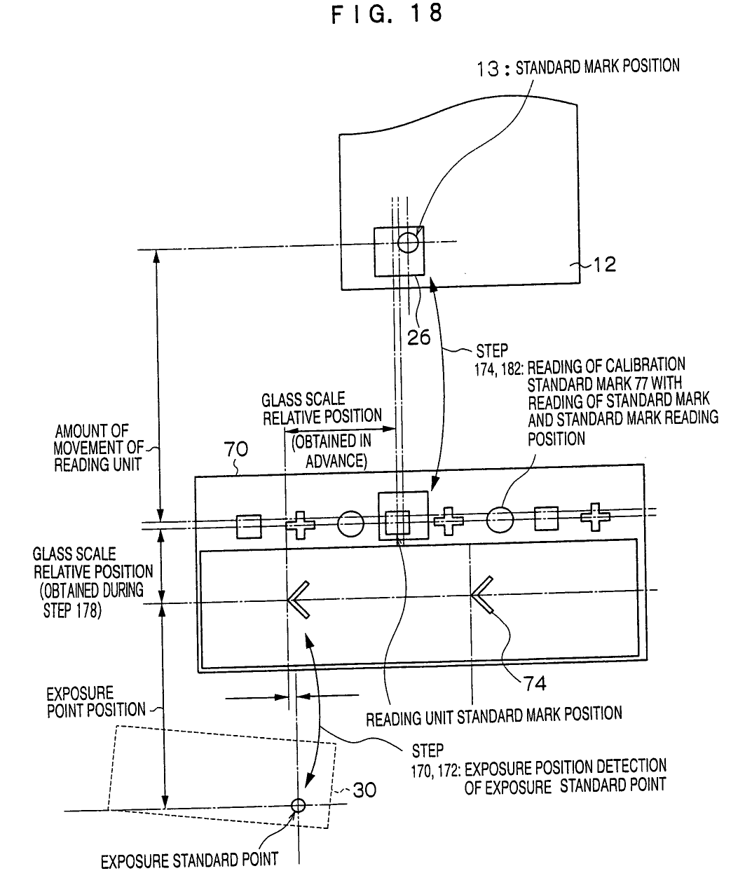

Next, the following exposure may be performed as an application of the present embodiment with the exposure device. This will be explained using the flowchart in FIG. 14 and the block diagram in FIG. 18. Detection marks 77A, 77B are read with the position of the CCD camera 26 that read the alignment marks 13 by the above-discussed operation either before or after reading the alignment marks 13 with the CCD camera 26 (step 174). As mentioned above, the absolute position data of the detection marks 77A, 77B is measured in advance with a separate measuring section and stored in the controller 28. The position data of the alignment marks 13 read with the CCD camera 26 is obtained as the position data that designates the absolute position data of the detection marks 77A, 77B as the standard (step 176).

Next, the beam position on the exposure surface when a specific pixel of the DMD 36 is illuminated is measured (step 170) with the above-described process from step 160 to step 164 in FIG. 13 and the beam position data is obtained (step 172). This is the relative position data with respect to the exposure standard point of the beam position detection unit 70A.

The beam position detection unit 70A and the camera position detection unit 70B are provided on the same standard board 70 and their relative position relations are measured in advance with a separate measuring section (step 178).

In this manner, the beam position of the exposure standard point on the exposure surface relative to the beam position detection unit 70A and the alignment mark position with the camera position detection unit 70B as the standard can be obtained. In other words, the relative positions of the beam position detection unit 70A and camera position detection unit 70B are measured so the position data of the alignment mark 13, with the beam position detection unit 70A as the standard, can be obtained.

The alignment mark 13 is read by the CCD camera 26 (step 182) at the stage where the photosensitive material is exposed and the position data is obtained based on the read alignment mark 13 (step 184). The controller 28 calculates standard position data on the basis of the detection marks 77A, 77B of the alignment mark 13 as the standard (step 186) with the processes of steps 174 and 176. Further, the controller 28 allots each pixel of the DMD 36 relative to the image data based on the beam position data of the exposure standard point relative to the beam position detection unit 70A and the position data of the alignment mark 13 relative to the beam position detection unit 70A. These are thus allotted so that the alignment mark 13 on the image data of the exposure image matches with the alignment mark 13 relative to the beam position detection unit 70A, and each pixel of the DMD 36 is modulated in response to the image data, and the exposure image is exposed (step 188).

By exposing with the applied example of the present embodiment as explained above, the position relations of the standard mark position and the exposure point position are known due to position measurement of the reading unit standard mark (detection mark 77) in which the relative position relation with the beam position detection unit 70A is known and of the alignment mark 13 being performed at the CCD camera 26. Based on this data, a drawn image can be exposed at high resolution.

That is, the data for each of the alignment mark 13 and the exposure standard point of the exposure position are obtained as the relative positions for the same scale (beam position detection unit 70A or camera position detection unit 70B). Exposure is performed based on the position data of the alignment mark 13 and the exposure point standard position data, so a drawn image can be exposed on a photosensitive material at high resolution.

Explanations were given where the exposure standard point was one point, however, a drawn image can be exposed on a photosensitive material at even higher resolution by position measurement on the basis of multiple pixels as the exposure standard points.

Further, in the present embodiment, the standard board 70 having the camera position detection unit 70B at the stage 14 on which the 12 is mounted is provided, and is set such that photographing of the detection marks 77A, 77B with the CCD camera 26 is possible, in a state where the photosensitive material 12 is mounted on the stage 14, is made possible. Due to this, even when the photosensitive material 12 is exposed with the exposure device 10, the alignment function can perform calibration, thus simplifying the calibration process.

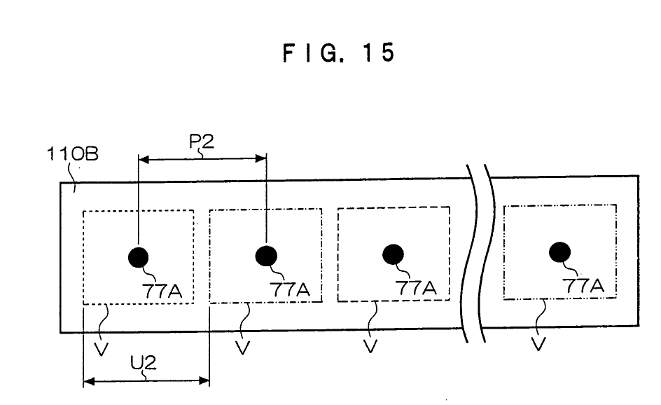

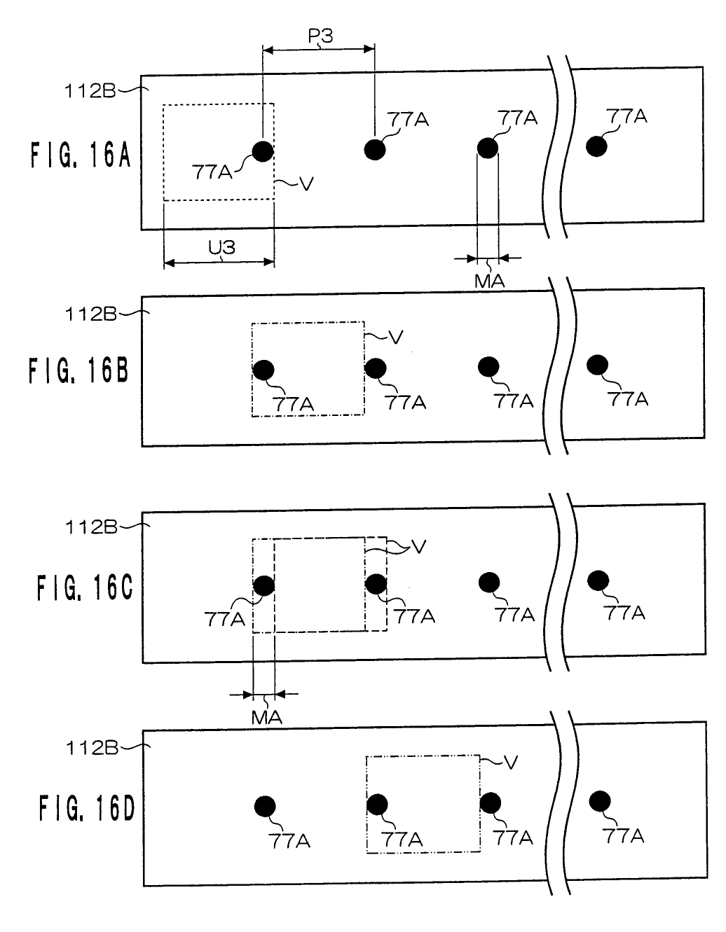

Further, alternate examples of cases where the detection marks provided on the camera position detection unit 70B of the above-described standard board 70 are of one type are shown in FIGS. 15 and 16.

The camera position detection unit 70B shown in FIG. 15 has only multiple circular detection marks 77A arranged along the X axis at predetermined intervals. In this alternate example, the arrangement pitch P2 of the multiple detection marks 77A and the movement unit U2 of the CCD camera 26 in the X direction are set to be the same or equal (P2=U2). Furthermore, each detection mark 77A is arranged so as to be positioned in the center of the field of view (photographing view) V of the CCD camera 26.

Further, in the camera position detection unit 70B shown in FIGS. 16A through 16D, only multiple circular detection marks 77A are arranged along the X axis at predetermined intervals. In this alternate example, the arrangement pitch P3 of the multiple detection marks 77A and the length measurement L in the X direction of the view V of the CCD camera 26 are also set equally (P3=L). Further, in this example, a movement unit U3 of the CCD camera 26 in the X direction is set at the width measurement MA of the detection marks 77A (U3=MA).

In this manner, even in cases where one type of detection mark is provided on the camera position detection unit 70B, by employing the above-described settings, it is possible to photograph only one detection mark 77A from among multiple arranged marks. This is the case in either position reached in the movement unit (U2/U3) step of the CCD camera 26. In these alternate examples, it is not necessary to use image processing such as pattern matching in order to discern which of the two types of detection marks 77A, 77B of the above-described embodiment were photographed by the CCD camera 26. Accordingly, processing relating to calibration operations can be simplified.

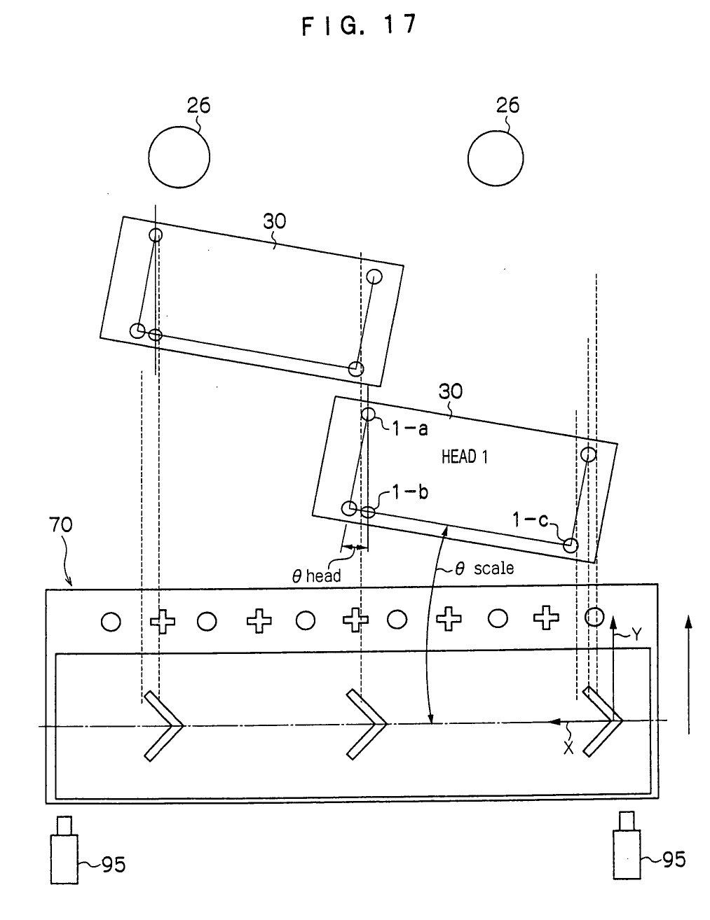

An angle measurement method for the standard board and the exposure head is shown in FIG. 17.

As shown in FIG. 17, each exposure head 30 is made such that exposure ON/OFF is possible for each pixel.

That is, a digital micro-mirror device (DMD) 36 is provided as a spatial light modulation element that modulates respective incident light beams to each pixel in accordance with image data. When the laser light that emerges from the exposure head 30 is irradiated on the DMD 36, and the micro-mirrors of the DMD 36 are in the ON state, the reflected laser light is image formed on the exposure surface of the photosensitive material 12 by a lens system. The laser light is turned ON or OFF by each pixel, and the photosensitive material 12 is exposed with pixel units (exposure area) of substantially the same number as the number of pixels used by the DMD 36.

The standard board 70 (beam position detection unit 70A) having the detection slits 74 that detect the exposure position with laser beams is provided as a detection unit for the exposure beams. Further, at least two detection slits 74 are provided per one exposure head 30.

Firstly, pixels 1-a, 1-b, and 1-c in the head 1 of FIG. 17 are gradually illuminated (i.e., in sequence). From among these, by finding the pixel positions (coordinates) in 1-a, 1-b of the head 1 that are lined in a straight line in the scanning direction (Y direction) the θ head (θ head_1) which is the angle of the head 1 relative to the scanning direction, can be calculated.

Further, by finding the pixel positions (coordinates) in 1-a, 1-b of the head 1 that are lined in a straight line in the scanning direction (Y direction) the θ head (θ head_1) which is the angle of the head 1 relative to the scanning direction, can be calculated.

Similarly, the head angle θ head_hn (head 1 to head n) of the multiple exposure heads 30 and the angle θ scale_hn of the standard board 70 are found, and their respective average values are adjusted to become equal by adjusting the angle of the standard board 70 with an angle-adjusting device 95.

Correct angle adjustment of the standard board 70 in the direction perpendicular to the scanning direction (Y-direction) can be performed with the above-described adjustment, so the pixels in the multiple exposure heads 30 and the position of the alignment camera 26 can be measured with an accurate coordinate system. Accordingly, exposure with accurately corrected exposure position alignment can be realized.

That is, since the angle of the head 1 to the scanning direction and the angle of the head 1 to the standard board 70 can be detected, detection and calibration of the angle of the scanning direction and the standard board 70 can be performed.

By configuring the invention as above, the standard board 70, which becomes the coordinate standard in the exposure device 10, can perform high-resolution position corrections on its own. Due to this, when there is time-dependent change inside the exposure device 10, e.g., when the scanning direction of the stage 14 changes or in cases where the mounting angle of the standard board 70 changes relative to the scanning direction, a high-resolution measuring device is not necessary to measure the scanning direction. It is possible to perform calibration with only the functions within the device so the overall reliability against time-dependent change of the exposure device 10 increases.

Detailed explanations of the present invention were given with regard to the above-described embodiment, however, the present invention is not limited thereto. Other embodiments within the scope of the present invention are also possible.

For example, in the above embodiment, the detection marks (calibration standard marks) were explained in cases where they have two types, circular and cross-shaped marks. It is possible to use detection marks besides those that are circular or cross-shaped and furthermore, it is possible to use three or more types of detection marks. In these cases, as described above, by regulating the predetermined conditions of the field of view of the CCD camera 26 and the movement unit and the arrangement pitch of the detection marks, functions on par with the above can be achieved.

Moreover, with the exposure of the photosensitive material 12 of the exposure device 10 in the above-described embodiment, the explanation concerned scanning exposure of the photosensitive material 12 while the stage 14 is in motion, but the exposure process is not limited to this scanning exposure only. For example, the photosensitive material 12 can be moved to the first exposure position, stopped once, and exposure of only preset exposure regions can be performed, after which the photosensitive material 12 can be moved to the next exposure position, stopped again and exposure of only preset exposure regions can be performed. In this manner, a process in which the photosensitive material 12 is moved, stopped at exposure positions, and image exposure performed can be repeated over and over.

Further, in the exposure device 10 of the above-described embodiment, the invention was explained where the exposure head is provided with a DMD serving as the spatial modulation element. Besides this type of reflective-type spatial light modulation element, transparent SLM-elements (LCD) can also be used. For example, it is possible to use micro-electro mechanical systems (MEMS)-type SLM-elements or optical elements that modulate transmitted light with electro-optical effects (PLZT elements) or liquid crystal shutter arrays such as liquid crystal light shutters (FLC), and other nonMEMS-type SLM elements can also be used. MEMS is a general term for a micro-system in which micro-sized sensors, actuators, and control circuits have been integrated with micro-machining technology having an IC manufacture process as the base. MEMS-type SLM-elements refer to those that are driven by electrical electromechanical operations using static electricity. Further, a device configured such that multiple grating light valves (GLV) are lined two-dimensionally can also be used. When utilizing devices using these reflective-type SLM-elements (GLV) and transmitting-type SLM-elements (LCD) in the configuration, other light sources besides the above-described laser, such as lamps and the like, can be used.

A variety of light sources can be applied in the above-described embodiment. It is possible to use a fiber array light source provided with multiple integrated laser light sources. It is also possible to use a fiber array light source, i.e., a light source arrayed and provided with one optic fiber that radiates a laser inputted from a single semiconductor having one luminous point. Light sources in which multiple luminous points are arranged two-dimensionally such as LD arrays and organic EL arrays may also be applied.

With regard to photosensitive materials used in the above-described exposure device 10, it is possible to use either photon-mode photosensitive materials in which direct information is recorded by exposure, or heat-mode photosensitive materials in which information is recorded with the heat generated by exposure. When using photon-mode photosensitive materials, lasers such as GaN-type semiconductor lasers or wavelength modulating solid lasers can be used in the laser device. When using heat-mode photosensitive materials, lasers such as AlGaAs-type semiconductor lasers (infrared lasers) or solid lasers can be used in the laser device.

In the present invention, the beam detection unit and the reading section position scale can be provided in a unified manner.

Further, with the present invention, the beam detection unit and the reading position calibration component can also be provided in a unified manner.

Moreover, with the present invention, the beam position detection unit measures the exposure point position of the light beam at multiple measuring points not lined in the scanning direction relative to the exposure unit. The invention can also be provided with an angle detection unit that detects the angle relative to the scanning direction of the beam position detection section from the exposure section measured at multiple points.

Furthermore, with the present invention, an image data correcting unit can also be provided that corrects image data exposed on the exposing surface, based on the angle relative to the scanning direction of the beam position detection unit detected by the angle detection unit.

The present invention can also be provided with an angle adjusting unit that adjusts the angle relative to the scanning direction of the beam position detection unit based on the angle relative to the scanning direction of the beam position detection unit detected by the angle detection unit.

Further, with the exposure method of the present invention, the beam position detection unit can measure the exposure point position of the light beam at multiple measuring points that are not lined in the scanning direction relative to the exposure section. The invention can also use an angle detection unit that detects the angle relative to the scanning direction of the beam position detection section from the exposure point position measured at multiple points. The invention can also comprise using an image data correcting unit that corrects image data exposed on the exposing surface based on the angle relative to the scanning direction of the beam position detection unit detected by the angle detecting unit.

Furthermore, with the exposure method of the present invention, the beam position detection unit can measure the exposure point position of the light beam at multiple measuring points not lined in the scanning direction relative to the exposure section. The invention can also use an angle detection unit that detects the angle relative to the scanning direction of the beam position detection section from the exposure point position measured at multiple points. The invention can also comprise using an angle adjusting unit that adjusts an angle relative to the scanning direction of the beam position detection unit based on the angle relative to the scanning direction of the beam position detection unit detected by the angle detecting unit.

With the calibration method of the exposure device of the present invention, the exposure device may have a section provided with a detection unit that detects the exposure position with light beams. In case of having such a section, a calibration component will be provided uniformly with the section provided with the detection unit. With this arrangement, exposure position data of the light beam detected by the detection unit and calibration data are calculated, and the standard position data is made to reflect the resulting calibration data. In this manner, calibration of the exposure position adjustment function of the exposure device can be included.

1. An exposure device comprising:
a moving unit, on which a photosensitive material is mounted provided with a standard mark that is the standard of an exposure position, and which moves the photosensitive material in a direction along a scanning direction;
a reading unit that reads the standard mark of the photosensitive material mounted on the moving unit;
an exposure unit that exposes the photosensitive material moved by the moving unit with light beams modulated in accordance with image data;
a control unit that performs exposure position adjustment with the light beams based on the standard position data obtained by the reading of the standard mark by the reading unit with the exposure of the exposure unit, controls the exposure unit, and makes the exposure unit operate exposure;
a reading unit position scale, which is provided with a plurality of reading unit standard marks arranged along the moving direction of the reading unit and which is arranged in a position where it is possible for the plurality of reading unit standard marks to be read by the reading unit;
a read position data storing unit that, when the standard marks are read by the reading unit, which is arranged in a position for reading at least one standard mark from the plurality of reading unit standard marks, stores the position data of the reading unit obtained by the reading;
a beam position detection unit provided with a detection unit that detects an exposure position with light beams;
an exposure point position information storage unit that stores exposure point position data obtained by detecting the exposure point position of a predetermined light beam outputted from the exposure unit with the beam position detection unit, wherein
with the exposure of the photosensitive material, the control unit reads out the standard position data read out from the data storage unit and the exposure point position data from the exposure point position information storage unit, and the image data is exposed from the relative position relation of the reading unit standard mark of the beam position detection unit based on the standard position data and the exposure point position data.

2. The exposure device of claim 1, wherein the beam position detection unit and the reading unit position scale are provided uniformly.

3. An exposure device comprising:
a moving unit, on which a photosensitive material is mounted provided with a standard mark that is the standard of an exposure position, and which moves the photosensitive material in a direction along a scanning direction;
a reading unit that reads the standard mark of the photosensitive material mounted on the moving unit;
an exposure unit that exposes the photosensitive material moved by the moving unit with light beams modulated in accordance with image data;
a control unit that performs exposure position adjustment with the light beams based on the standard position data obtained by the reading of the standard mark by the reading unit with the exposure of the exposure unit; controls the exposure unit, and makes the exposure unit operate exposure;
a reading position calibration component that is provided with a plurality of calibration standard marks arranged along the moving direction of the reading unit and is set in a position where the plurality of calibration standard marks can be read by the reading unit;
a calibration data storage unit, where at least one of a plurality of calibration standard marks is read with the reading unit arranged in a position to read the standard mark, and the calibration data storage unit stores calibration data calculated based on position data of the reading unit obtained by the reading;
a beam position detection unit provided with a detection unit that detects an exposure position with light beams;
an exposure point position information storage unit that stores exposure point position data obtained by detecting the exposure point position of a predetermined light beam outputted from the exposure unit with the beam position detection unit, wherein
with the exposure of the photosensitive material, the control unit reads out the calibration data from the calibration data storage unit and the standard position correcting data in which the calibration data is reflected in the standard position data, and the exposure point position data from the exposure point position information storage unit, and the image data is exposed from the relative position relation of the reading unit standard mark of the beam position detection unit based on the standard position correcting data and the exposure point position data.

4. The exposure device of claim 3, wherein the beam position detection unit and the reading position calibration component are provided uniformly.

5. The exposure device of claim 1, wherein the beam position detection unit measures the exposure point position of the light beam at a plurality of measuring points not lined in the scanning direction relative to the exposure unit, and the exposure device is provided with an angle detection unit that detects the angle relative to the scanning direction of the beam position detection unit from the exposure point position measured at the plurality of measuring points.

6. The exposure device of claim 5 provided with an image data correcting unit that corrects image data exposed on an exposure surface based on an angle relative to the scanning direction of the beam position detection unit detected by the angle detection unit.

7. The exposure device of claim 5 provided with an angle adjusting unit that adjusts an angle relative to the scanning direction of the beam position detection unit based on an angle relative to the scanning direction of the beam position detection unit detected by the angle detection unit.

8. An exposure device comprising:
a moving unit, on which a photosensitive material is mounted provided with a standard mark that is the standard of an exposure position, and which moves the photosensitive material in a direction along a scanning direction;
a reading unit that is movable in a direction that intersects the scanning direction and which reads the standard mark of the photosensitive material mounted on the moving unit;
an exposure unit that exposes the photosensitive material, moved by the moving unit, with light beams modulated in accordance with image data after reading by the reading unit;
a control unit that performs exposure position adjustment, with the light beams based on the standard position data obtained with the reading by the reading unit, with the exposure by the exposure unit; controls the exposure unit, and makes the exposure unit operate exposure;
a calibration component provided on the moving unit and provided with a plurality of calibration standard marks arranged at preset intervals along the moving direction of the reading unit and set in a position where the plurality of calibration standard marks are readable by the reading unit; and
a data storage unit that stores calibration data calculated based on position data of the reading unit obtained by reading of the reading unit, which is set in a position to read at least one standard mark from the plurality of calibration standard marks, wherein
with the exposure of the photosensitive material, the control unit reads out the calibration data from the data storage unit and makes the standard position data reflect the calibration data and performs exposure position adjustment, and controls the exposure unit to perform exposure operation.

9. An exposure method that uses a moving unit, on which a photosensitive material is mounted provided with a standard mark that is the standard of an exposure position, and which moves the photosensitive material in a direction along a scanning direction; a reading unit that reads the standard mark of the photosensitive material mounted on the moving unit; an exposure unit that exposes the photosensitive material moved by the moving unit with light beams modulated in accordance with image data; a control unit that performs exposure position adjustment with the light beams based on the standard position data obtained by the reading of the standard mark by the reading unit with the exposure of the exposure unit; controls the exposure unit, and makes the exposure unit operate exposure; the exposure method comprising:
using a reading unit position scale, which is provided with a plurality of reading unit standard marks arranged along the moving direction of the reading unit and which is arranged in a position where it is possible for the plurality of reading unit standard marks to be read by the reading unit;
using a read position data storing unit that, when the standard marks are read by the reading unit, which is arranged in a position for reading at least one standard mark from the plurality of reading unit standard marks, stores the position data of the reading unit obtained by the reading;
using a beam position detection unit provided with a detection unit that detects an exposure position with light beams;
using an exposure point position information storage unit that stores exposure point position data obtained by detecting the exposure point position of a predetermined light beam outputted from the exposure unit with the beam position detection unit, wherein
using, with the exposure of the photosensitive material, the control unit that reads out the standard position data read out from the data storage unit and the exposure point position data from the exposure point position information storage unit, and
exposing the image data from the relative position relation of the reading unit standard mark of the beam position detection unit based on the standard position data and the exposure point position data.

10. An exposure method that uses a moving unit, on which a photosensitive material is mounted provided with a standard mark that is the standard of an exposure position, and which moves the photosensitive material in a direction along a scanning direction; a reading unit that reads the standard mark of the photosensitive material mounted on the moving unit; an exposure unit that exposes the photosensitive material moved by the moving unit with light beams modulated in accordance with image data; a control unit that performs exposure position adjustment with the light beams based on the standard position data obtained by the reading of the standard mark by the reading unit with the exposure of the exposure unit; controls the exposure unit, and makes the exposure unit operate exposure, the exposure method further comprising:
using a reading position calibration component, which is provided with a plurality of calibration standard marks arranged along the moving direction of the reading unit and which is arranged in a position where it is possible for the plurality of calibration standard marks to be read by the reading unit;
using a calibration data storage unit, where at least one of a plurality of calibration standard marks is read with the reading unit arranged in a position to read the standard mark, and the calibration data storage unit stores calibration data calculated based on position data of the reading unit obtained by the reading;
using a beam position detection unit provided with a detection unit that detects an exposure position with light beams;
using an exposure point position information storage unit that stores exposure point position data obtained by detecting the exposure point position of a predetermined light beam outputted from the exposure unit with the beam position detection unit;
using with the exposure of the photosensitive material, the control unit reads out the calibration data from the calibration data storage unit, the standard position correcting data made to reflect the calibration data in the standard position data, and the exposure point position data from the exposure point position information storage unit; and
exposing the image data from the relative position relation of the reading unit standard mark of the beam position detection unit based on the standard position correcting data and the exposure point position data.

11. The exposure method of claim 9, which uses the beam position detection unit that measures the exposure point position of the light beam at a plurality of measuring points not lined in the scanning direction relative to the exposure unit; an angle detection unit that detects the angle relative to the scanning direction of the beam position detection unit from the exposure point position measured at the plurality of measuring points; and an image data correcting unit that corrects image data exposed on an exposure surface based on an angle relative to the scanning direction of the beam position detection unit detected by the angle detection unit.

12. The exposure method of claim 9, which uses the beam position detection unit that measures the exposure point position of the light beam at a plurality of measuring points not lined in the scanning direction relative to the exposure unit; an angle detection unit that detects the angle relative to the scanning direction of the beam position detection unit from the exposure point position measured at the plurality of measuring points; and an angle adjusting unit that adjusts an angle relative to the scanning direction of the beam position detection unit based on an angle relative to the scanning direction of the beam position detection unit detected by the angle detection unit.

13. An exposure method using a moving unit, on which a photosensitive material is mounted provided with a standard mark that is the standard of an exposure position, and which moves the photosensitive material in a direction along a scanning direction; a reading unit that is movable in a direction that intersects the scanning direction and which reads the standard mark of the photosensitive material mounted on the moving unit; an exposure unit that exposes the photosensitive material, moved by the moving unit, with light beams modulated in accordance with image data after reading by the reading unit; a control unit that performs exposure position adjustment, with the light beams based on the standard position data obtained with the reading by the reading unit, with the exposure by the exposure unit; controls the exposure unit, and makes the exposure unit operate exposure; the exposure method further comprising:
using a calibration component provided on the moving unit and provided with a plurality of calibration standard marks arranged at preset intervals along the moving direction of the reading unit and set in a position where the plurality of calibration standard marks are readable by the reading unit; and
using a data storage unit that stores calibration data calculated based on position data of the reading unit obtained by reading of the reading unit, which is set in a position to read at least one standard mark from the plurality of calibration standard marks; wherein with the exposure of the photosensitive material, the control unit reads out the calibration data from the data storage unit and makes the standard position data reflect the calibration data and performs exposure position adjustment, and controls the exposure unit to perform exposure operation.

14. A calibration method of an exposure device, wherein a standard mark that is an exposure position standard provided on a photosensitive material is read by a reading unit that is movable in a direction intersecting the scanning direction of the photosensitive material and exposure position adjustment is performed on the photosensitive material based on the obtained standard position data, and calibration of the exposure position adjustment function of the exposure device, which exposes the photosensitive material with light beams modulated in accordance with image data while moving the photosensitive material in the scanning direction with a moving unit, is performed; and prior to reading the standard mark with the reading unit, a calibration component, provided with a plurality of calibration standard marks arranged at preset intervals along the moving direction of the reading unit, is set in a position where reading by the reading unit is possible, where at least one of the plurality of calibration standard marks is read by the reading unit set in a position to read the standard marks, calibration data is calculated based on the position data obtained by the reading of the reading unit, and calibration of the exposure position adjustment function of the exposure device is performed by making the standard position data reflect the calibration data.

15. The calibration method of claim 14, wherein the exposure device has a section provided with a detection unit that detects an exposure position with the light beam and a calibration component provided uniformly with the detection unit, and exposure position data of a light beam detected by the detection unit and the calibration data are calculated, and calibration of the exposure position adjustment function of the exposure device is performed by making the standard position data reflect the found calibration data.

16. The calibration method of claim 14, wherein the moving unit has a stage on which the photosensitive material is mounted and the calibration standard component is arranged on the stage such that reading of the calibration standard mark is possible by the reading unit when the photosensitive material is in a mounted state on the stage.
